(19) United States
(12) Patent Application Publication
(10) Pub. No.: US 2025/0059437 A1
(43) Pub. Date: Feb. 20, 2025

(54) DEGRADABLE LUMINESCENT POLYMERS

(71) Applicant: UCHICAGO ARGONNE, LLC, Chicago, IL (US)

(72) Inventors: Jie Xu, Chicago, IL (US); Yukun Wu, Bolingbrook, IL (US); Wei Liu, Chicago, IL (US)

(73) Assignees: UCHICAGO ARGONNE, LLC, Chicago, IL (US); THE UNIVERSITY OF CHICAGO, Chicago, IL (US)

(21) Appl. No.: 18/234,311

(22) Filed: Aug. 15, 2023

(51) Int. Cl. C09K 11/06; C08G 61/12; C09K 11/02

(52) U.S. Cl. CPC C09K 11/06; C08G 61/127; C09K 11/02; C08G 2261/124; C08G 2261/1412; C08G 2261/149; C08G 2261/312; C08G 2261/3241; C08G 2261/41; C08G 2261/522; C08G 2261/73; C09K 2211/1425; C09K 2211/1433; C09K 2211/1466

(57) ABSTRACT

Provided herein are depolymerizable thermally activated delayed fluorescence polymers with exceptional light-emitting properties and programmable depolymerization under specific stressors.

### STATEMENT OF GOVERNMENT SUPPORT

This invention was made with government support under Contract No. DE-AC02-06CH11357 awarded by the United States Department of Energy to UChicago Argonne, LLC, operator of Argonne National Laboratory. The government has certain rights in the invention.

### FIELD

The disclosure relates generally to luminescent polymers that are capable of depolymerization. More particularly, the disclosure relates to luminescent polymers capable of depolymerization under high temperature and/or acidic conditions.

### BACKGROUND

Organic luminescent materials have been widely used as the key materials in a number of photonic technologies, including OLED displays, fluorescent bioimaging, and optical therapies. Taking OLED displays as an example, per a report published by Data Bridge Market Research in 2021, the global OLED market size was valued at USD 38.7 billion in 2021 and is expected to grow at a compound annual growth rate of 13.2% from 2022 to 2029, indicating a substantial demand for organic emitters. With the advent of modern display development, emerging trends such as large-area, foldable, and stretchable displays, as well as low-cost manufacturing, have led to rapid development and applications of polymer-type emitters. This is due to their solution processability, mechanical deformability, and chemical tunability. Accompanied by the rapidly increased use of luminescent polymers, on the other hand, the end-life disposal of these polymers, similar to the plastic pollution issues of commodity polymers at large, could potentially pose severe threats to the natural environment. Therefore, it is desirable to incorporate degradability (i.e., depolymerizability) into polymer-type emitters to minimize their impact on the environment. Despite efforts to endow degradable properties to the light-emitting polymer, only low external quantum efficiencies (EQE) (no more than 1.5%) have been achieved. These polymer designs are based on fluorescence-(FL) type emitters, and their efficiency is fundamentally limited by the photophysics nature of only harvesting singlet excitons with the maximum internal quantum efficiency (IQE) of 25%.

To maintain the technological relevance, luminescent polymers need to have high light-emitting efficiencies, which can be obtained from either spin-orbit-coupling induced phosphorescence (PH) or thermally activated delayed fluorescence (TADF). Among these two options, heavy-metal-free TADF emitters have attracted most of the efforts in polymer designs due to their environmentally friendliness and low-cost. By minimizing the singlet and triplet energy states splitting (ΔE_{ST}), TADF emitters can convert non-radiative triplet excitons into radiative singlet excitons through reverse intersystem crossing (RISC), offering a pathway towards 100% IQE.

Solution processable luminescent polymers are of great interest in a number of photonics technologies, including OLED displays, bioimaging, medical diagnosis, bio-stimulation, and security signage. However, their rapidly increased use could potentially generate a significant amount of plastic waste potentially posing severe threats to the environment.

### SUMMARY

There has been no previous report on imparting depolymerizability into the TADF polymers. There are several challenges associated with this, including (i) selecting cleavable building blocks that are compatible with the TADF emission (especially not quenching long-lived triplet excitons), while maintaining efficient charge transport in the polymer networks; (ii) designing and synthesizing TADF polymers with those cleavable building units; and (iii) controllable depolymerizations in an operational environment and in response to external stressors.

Luminescent polymers of the disclosure are designed to include depolymerizable properties, which can mitigate the adverse lifecycle impacts of luminescent polymers.

A depolymerizable and luminescent polymer in accordance with the disclosure can have a structure of Formula (I):

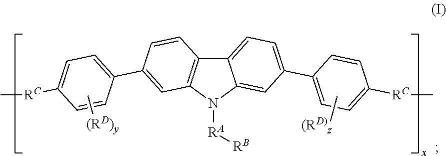

wherein x is an integer selected from 0 to 50; R^{A} is an electron acceptor group; R^{B} is an electron donor group; R^{C} is a linker group, comprising R^{E}—(CH₂)ₙ—R^{E}, R^{E}—C(CH₃)₂(CH₂)ₙC(CH₃)₂—R^{E}, R^{E}—(CH₂CH₂O)ₙ—R^{E}, or R^{E}—(Si(CH₃)₂O)ₙ—R^{E}; R^{E} is

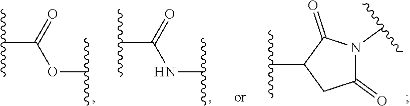

each n is 1 or 2; each y and z are independently 0, 1, or 2; and R^{D} is C₁₋₆alkyl or C₁₋₆haloalkyl.

In accordance with the disclosure, the depolymerizable and luminescent polymer can have a structure of Formula (I); wherein R^{A} is

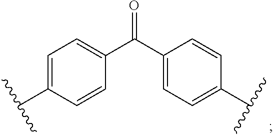 [SMILES: *c1ccc(C(=O)c2ccc(*)cc2)cc1]

### R^{B} is

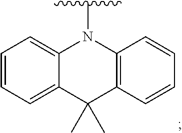 [SMILES: *N1c2ccccc2C(C)(C)c2ccccc21]

R^{C} is R^{E}—C(CH₃)₂(CH₂)₂C(CH₃)₂—R^{E}; R^{E} is

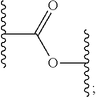 [SMILES: *OC(*)=O]

each of y and z are 1; and R^{D} is CH₃.

A depolymerizable and luminescent polymer in accordance with the disclosure can comprise a plurality of guest emitters dispersed in a host polymer wherein the host polymer comprises a plurality of host monomers and a plurality of cleavable linker groups. The linker groups comprise R^{E}—(CH₂)ₙ—R^{E}, R^{E}—C(CH₃)₂(CH₂)ₙC(CH₃)₂—R^{E}, R^{E}—(CH₂CH₂O)ₙ—R^{E}, or R^{E}—(Si(CH₃)₂O)ₙ—R^{E}; each n is 1 or 2; and R^{E} is

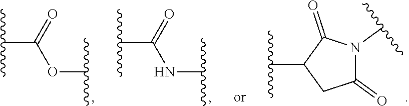

In accordance with the disclosure, the depolymerizable and luminescent polymer can comprise a host polymer, wherein the host monomer is

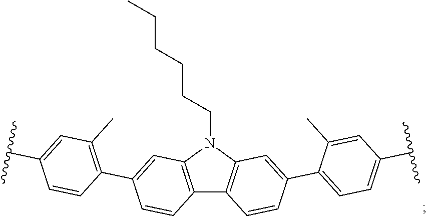 [SMILES: *c1ccc(-c2ccc3c4ccc(-c5ccc(*)cc5C)cc4n(CCCCCC)c3c2)c(C)c1]

the linker group is R^{E}—C(CH₃)₂(CH₂)₂C(CH₃)₂—R^{E}; and R^{E} is

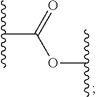 [SMILES: *OC(*)=O]

and the guest emitter is

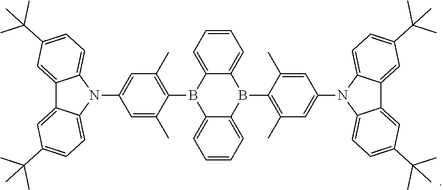 [SMILES: Cc1cc(-n2c3ccc(C(C)(C)C)cc3c3cc(C(C)(C)C)ccc32)cc(C)c1B1c2ccccc2B(c2c(C)cc(-n3c4ccc(C(C)(C)C)cc4c4cc(C(C)(C)C)ccc43)cc2C)c2ccccc21]

### BRIEF DESCRIPTION OF THE DRAWINGS

FIG. 1. Scheme of depolymerizable polymer synthesis and depolymerization with TADF or Host monomers, and linker precursor monomers.

FIG. 2. Scheme of Linker precursor monomer synthesis.

FIG. 3. Scheme of TADF monomer synthesis.

FIG. 4. Scheme of depolymerizable polymer synthesis with linker precursor monomers, and TADF and host monomers to form PDKCE and PC6E, respectively.

FIG. 5. Scheme of depolymerizable TADF polymer and a control polymer, PDKCE and PDKCM respectively, and TADF mechanism.

FIG. 6. DFT-calculated HOMO, LUMO, HOMO−1, and LUMO+1 distributions, as well as energy levels in the smallest electronic conjugation units of PDKCE and PDKCM

FIG. 7. Hole and particle distributions at lowest singlet state (S₁) for the repeating units of polymers PDKCM and PDKCE, as well as the depolymerized product of PDKCE by heating.

FIG. 8. Electrostatic potential surfaces (EPS) for the repeating units of polymers PDKCM and PDKCE, as well as the depolymerized product of PDKCE by heating.

FIG. 9. Absorption spectra, and room temperature emission spectra collected from thin films of PDKCE and PDKCM.

FIG. 10a. Cyclic voltammetry (CV) test for PDKCE thin film at room temperature.

FIG. 10b. Cyclic voltammetry (CV) test for PC6E thin film at room temperature.

FIG. 11. Fluorescent/phosphorescent (FL/PH) spectra at low temperature (77 K) of the depolymerizable polymer PDKCE film.

FIG. 12. PL transient decays and PLQYs (insert) of PDKCE and PDKCM.

FIG. 13. Schematic of the OLED device for the characterization of the EL performance of PDKCE and PDKCM as the host-free EML. ITO, indium tin oxide; PEDOT:PSS, Poly(3,4-ethylenedioxythiophene) polystyrene sulfonate; TPBI, 2,2,2-(1,3,5-Benzinetriyl)-tris(1-phenyl-1H-benzimidazole); LiF, lithium fluoride; Al, alumina

FIG. 14. Representative current density-luminance-voltage traces for PDKCE and PDKCM.

FIG. 15. Current density-voltage curves for hole-only and electron-only devices based on PDKCE. Electron-only device structure: Al (80 nm)/PDKCE (90 nm)/LiF (1 nm)/Al (80 nm). Hole only device structure: Al (80 nm) MoO₃ (10 nm)/PDKCE or PDKCM (90 nm)/ITO (80 nm).

FIG. 16. Current density-voltage curves for hole-only devices based on PDKCE and PDKCM. Hole only device structure: Al (80 nm) MoO₃ (10 nm)/PDKCE or PDKCM (90 nm)/ITO (80 nm).

FIG. 17. Representative EQE-current density traces and normalized EL spectra (inset) for PDKCE and PDKCM.

FIG. 18. Average number molecular weight (Mₙ) of PDKCE and PDKCM monitored over time in the mixed tetrahydrofuran (THF) and hydrogen chloride (HCl) solution.

FIG. 19. Normalized average number molecular weight (Mₙ/Mₙ₀) of PDKCE monitored over time in the mixed tetrahydrofuran (THF) and sodium hydroxide solution (1 M) at different temperatures.

FIG. 20. The TGA curves of PDKCE and PEKCM with a heating rate of 15° C./min.

FIG. 21. The TGA curves of PDKCE at different temperatures with a heating rate of 15° C./min.

FIG. 22. Mapping of DFT calculated bond dissociation enthalpy of the smallest electronic conjugation unit for depolymerizable TADF polymer PDKCE.

FIG. 23. Chemical structure of thermal depolymerization product from polymers PDKCE and PC6E, left and right, respectively.

FIG. 24. NMR spectra of PDKCE before (top spectrum) and after depolymerization (bottom spectrum).

FIG. 25a. The absorption spectra, and normalized room temperature PL spectra of PDKCE before and after heated at 210° C. for 1 h. The 2^{nd} harmonic peaks caused by excitation around 600 nm in PL spectra were removed for clearance.

FIG. 25b. The absorption spectra, and normalized room temperature PL spectra of PDKCM before and after heated at 210° C. for 1 h. The 2^{nd} harmonic peaks caused by excitation around 600 nm in PL spectra were removed for clearance.

FIG. 26a. The heating influence on the transient PL characteristics of in 50 ns time-scale window. PDKCM film before and after heating at 210° C. for 1 h. The measurements are all conducted in the N₂ atmosphere at room temperature.

FIG. 26b. The heating influence on the transient PL characteristics of in 50 ns time-scale window. PDKCE film before and after depolymerization at 210° C. for 1 h. The measurements are all conducted in the N₂ atmosphere at room temperature.

FIG. 27. Influence of TB-ester and carboxylic acid on PLQY at room temperature of PDKCM with heating condition of 210° C. for 1 h.

FIG. 28. Mechanism of depolymerization induced TADF deactivation. A-D₁ and A-D₂ represent charge transfer states from benzophenone-acridine and benzophenone-carbazole A-D pairs, respectively. A-D₁ and A-D₂ represent charge transfer states from benzophenone-acridine and benzophenone-carbazole A-D pairs, respectively. S₀, S₁, and T₁ stand for ground state, lowest singlet state, and lowest triplet state energy levels, respectively. ISC and RISC, stand for intersystem crossing and reverse ISC, respectively. Fₚ, and F_{d} stand for prompt fluorescence, and delayed fluorescence, respectively.

FIG. 29. PLQY at room temperature, and hole/particle distributions at T₁ state of PDKCE before and after depolymerization.

FIG. 30. Streak camera images in the time range of 0-5 μs and PLQYs at room temperature of PDKCE before and after depolymerization, left and right, respectively.

FIG. 31a. Streak camera images in the time range of 0-5 μs at room temperature of PDKCM before and after depolymerization, left and right, respectively.

FIG. 31b. Transient PL decay of PDKCE and PDKCM films before and after heating at 210° C. for 1 h, left and right, respectively.

FIG. 32. Schematic showing mechanism of depolymerization induced TADF deactivation.

FIG. 33. Depolymerizable TADF polymer was used to print a QR code. The depolymerization condition for the QR code is heating at 210° C. for 1 h.

FIG. 34. Average number molecular weights (Mₙ) and corresponding depolymerization degree (%) of PC6E monitored over time in mixed THF/HCl solution.

FIG. 35. The TGA curve of PC6E in the nitrogen atmosphere with a heating rate of 15° C./minute.

FIG. 36. Absorption spectrum of the PC6E film and low temperature (77K) phosphorescence spectrum of PC6E in 2-methyltetrahydrofuran solution.

FIG. 37. Schematic of energy levels for each material used in the OLEDs for the characterization of the EL performance of PC6E.

FIG. 38. Current density-luminance-voltage traces for the OLED devices with PC6E/x % tBuCzDBA as EML with different blending concentrations of 10%, 20%, 30%, 40%, and 100%

FIG. 39. Current density-EQE trances for the OLED devices with PC6E/x % tBuCzDBA as EML with different blending concentrations of 10%, 20%, 30%, 40%, and 100%

FIG. 40. EL spectra of the OLEDs with PC6E: x wt % tBuCzDBA as EML with different blending concentrations of 10%, 20%, 30%, 40% and 100%.

FIG. 41. PLQY of the host/guest light-emitting layers from blending film of depolymerizable host polymer PC6E and TADF emitter tBuCzDBA with different doping ratios (PC6E: x wt % tBuCzDBA, x=10, 20, 30, 40, and 100)

FIG. 42. Current density-voltage curves for hole-only devices based on PC6E blended with different concentrations (10%, 20%, 30%, 40%, and 100%) of tBuCzDBA. Hole only device structure: Al (80 nm) MoO₃ (10 nm)/PC6E: x wt % tBuCzDBA (90 nm)/ITO (80 nm).

### DETAILED DESCRIPTION

Provided herein are depolymerizable polymers which can programmable depolymerize under specific stressors. The polymers of the disclosure can demonstrate high OLED performance.

A depolymerizable, luminescent polymer in accordance with the disclosure can be of a compound of formula (I):

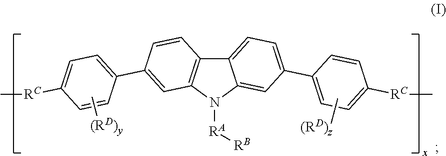

wherein:
x is an integer selected from 0 to 50;
R^{A} is an electron acceptor group;
R^{B} is an electron donor group;
R^{C} is a linker.

Alternatively, a depolymerizable luminescent polymer in accordance with the disclosure can be (i) a non-luminescent host polymer comprising a plurality of host monomers and linker groups, which depolymerizes in acid; and (ii) a plurality of guest monomers, each guest monomer comprising an electron acceptor group and an electron donor group.

It has been observed that by using a linker group, confirmed to be benign to electroluminescent properties, a luminescent polymer or a host polymer for an electroluminescent guest can be generated with depolymerizable properties and high OLED performance. For example, polymers of the disclosure can be used in producing an OLED with EQE up to 15.1%, which is an order of magnitude higher than previously reported OLEDs.

The polymers of the disclosure can be depolymerized under either mild acidic or heating conditions. The depolymerization can be achieved in the polymers of the disclosure with control of the kinetics for the final products of either oligomers or monomers and within a range of time windows from several days down to one minute. Advantageously, these polymers can be used for existing photoluminescent and electroluminescent technologies such as displays, medical imaging, optical stimulation, as well as enable new applications such as printed erasable emissive barcodes due to the depolymerization-induced electroluminescence deactivation.

### Depolymerizable TADF Polymer

A depolymerizable, luminescent polymer in accordance with the disclosure can be of a compound of formula (I):

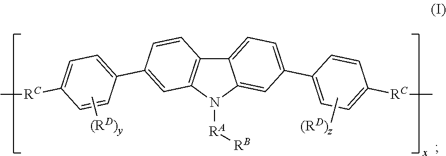

wherein:
x is an integer selected from 0 to 50;
R^{A} is an electron acceptor group;
R^{B} is an electron donor group;
R^{C} is a linker.

Compounds of formula I represent a TADF emitter. The linker in the compounds of formula I introduces a functional bond into the polymer to thereby provide depolymerizability. The functional bond remains stable throughout the fabrication process and during the polymer working life without affecting the TADF properties, but rapidly cleaves under orthogonal stressors.

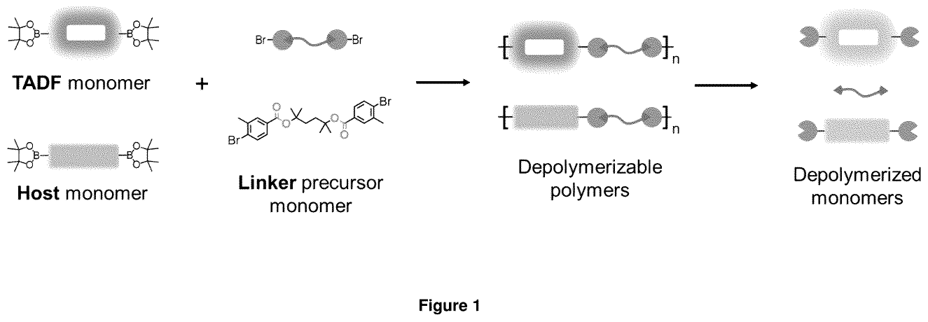

As shown schematically in FIG. 1, a TADF precursor monomer and a linker precursor monomer can be polymerized to form polymers of the disclosure. The linker monomer has a halogenated aryl moiety that can undergo a Suzuki coupling with the TADF monomer to form the polymer of the disclosure. The linker so incorporated into the polymer provides a cleavable moiety that can be cleaved under suitable conditions, such as mild acidic conditions and/or elevated temperature to thereby allow the controlled depolymerization of the polymer.

Generally, the bonds broken during depolymerization are different from the bonds formed during the polymerization. After depolymerization, the aryl moiety that was attached to the linker monomer remains attached to the depolymerized TADF monomer. As a result, the structure of the depolymerized TADF monomer is different from the TADF precursor monomer and the depolymerized TADF monomer does not retain the luminescent properties of the TADF precursor monomer.

In the polymers of the disclosure, x can be any integer greater than 1. In various cases, x is an integer from 1 to 50. In various cases, x is an integer in the range of 10 to 50. In various cases, x is an integer in the range of 25 to 50. In various cases, x is an integer in the range of 35 to 45.

In the polymers of the disclosure, each of y and z can be 0, 1, or 2. In various cases, at least one of y and z is 0. In various cases, at least one of y and z is 1. In various cases, at least one of y and z is 2. In various cases, each y and z are independently 0. In various cases, each y and z are independently 1. In various cases, each y and z are independently 2.

In the polymers of the disclosure, R^{D} can be C₁₋₆alkyl or C₁₋₆haloalkyl. In various cases, R^{D} is C₁₋₆alkyl. In various cases, R^{D} is C₁₋₆haloalkyl. In various cases, R^{D} is CH₃ or CF₃. In various cases, R^{D} is CH₃. In various cases, R^{D} is CF₃. In various cases, each of y and z are 1 or 2 and each R^{D} is CH₃.

In the polymers of the disclosure, R^{A} is an electron acceptor group. In the polymers of the disclosure, R^{B} is an electron donor group. Examples of electron acceptor groups that can be used as R^{A} and electron donor groups that can be used as R^{B} are provided below. Examples of linkers, R^{C}, are also provided below.

For example, R^{A} can be

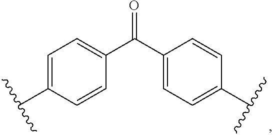 [SMILES: *c1ccc(C(=O)c2ccc(*)cc2)cc1]

### R^{B} can be

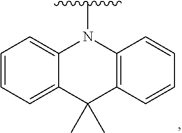 [SMILES: *N1c2ccccc2C(C)(C)c2ccccc21]

R^{C} can be R^{E}—C(CH₃)₂(CH₂)₂C(CH₃)₂—R^{E}, R^{E} can be

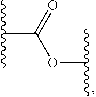 [SMILES: *OC(*)=O]

each of y and z can be 1, and R^{D} is CH₃.

### Host Polymer with Guest Emitters

A depolymerizable, luminescent polymer in accordance with the disclosure can include a host polymer doped with guest emitters. In such polymers, the guest emitters are dispersed within the host polymer. The host polymer includes a plurality of host monomers and linker groups, with the linker group defining a cleavable moiety through which the luminescent polymer can be controllably depolymerized.

As shown schematically in FIG. 1, a host monomer and a linker precursor monomer can be polymerized to form the host polymer. The linker precursor monomer has a halogenated aryl moiety that can undergo a Suzuki coupling with the host monomer to form the non-luminescent host polymer. Generally, the bonds broken during depolymerization are different from the bonds formed during the polymerization. After depolymerization, the aryl moiety that was attached to the linker monomer remains attached to the depolymerized host monomer and/or depolymerized host oligomer units. Upon depolymerization, the guest emitter disassociates and is separable from the host monomer and/or depolymerized host oligomer units. The guest emitter may be recovered after depolymerization for subsequent use.

In an example polymer, a TB-ester was incorporated in the host polymer of the host-guest type EML system to enhance light-emitting performance while preserving depolymerizability. It was observed that the TB-ester helped suppress concentration-induced quenching, primarily caused by the long-lived triplet excitons. For polymer-type emission material layer (EML) type systems, such host-guest design can be realized by doping a polymeric host with small-molecule TADF guest emitters. The host materials feature T₁ states (lowest triplet energy state) that are higher in energy than the guest TADF emitters to confine the excitons in the emitters. The guest emitters can be admixed with the host polymer by dissolving the host polymer and guest emitter in a suitable solvent. Removal of the solvent can result then result in deposition of a polymer film in which the guest emitters are dispersed within the host polymer, thereby resulting in a host polymer doped with the guest emitters.

Various host monomers can be used in the formation of the host polymer. The host polymer can have the same host monomer or can have two or more different host monomer types for forming the host polymer. Any host monomer or combination of host monomers can be used so long as the resulting host polymer has an energy level higher than the energy level of the guest emitter. For example, any of the electron donor and/or electron acceptor groups can be used as host monomers. Other examples of host monomers can be acridine, fluorene, or carbazole, optionally substituted with 1 or 2 C₁₋₆alkyl groups.

In the polymers of the disclosure, the guest emitter can be any known emitter molecules known in the art. For example, the guest emitter can include a combination of any of the electron acceptor groups and the electron donor groups identified below that is capable of exhibiting luminescence. For example, any combination that can be functional as a TADF emitter. Examples of guest emitters can include, but are not limited to,

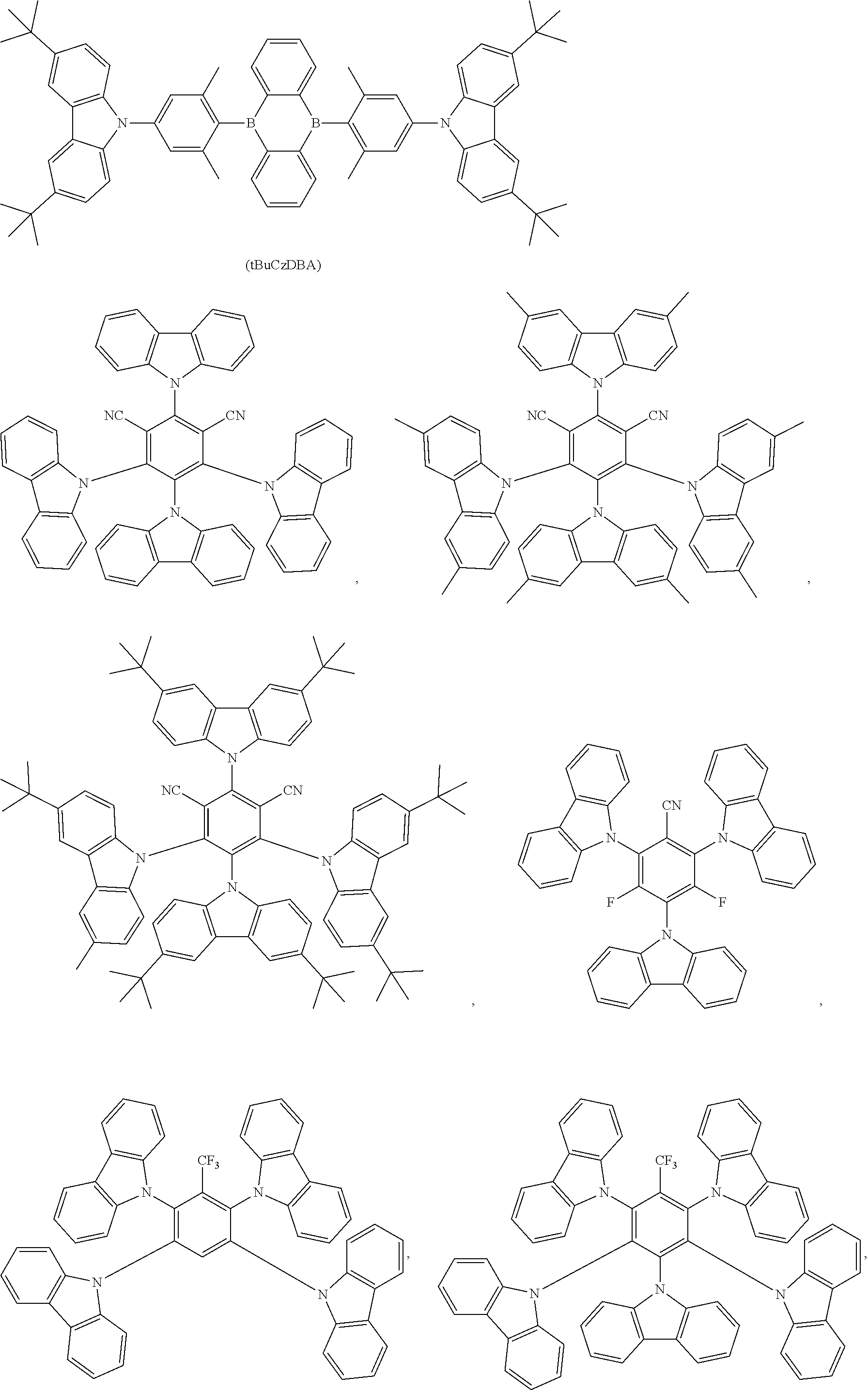

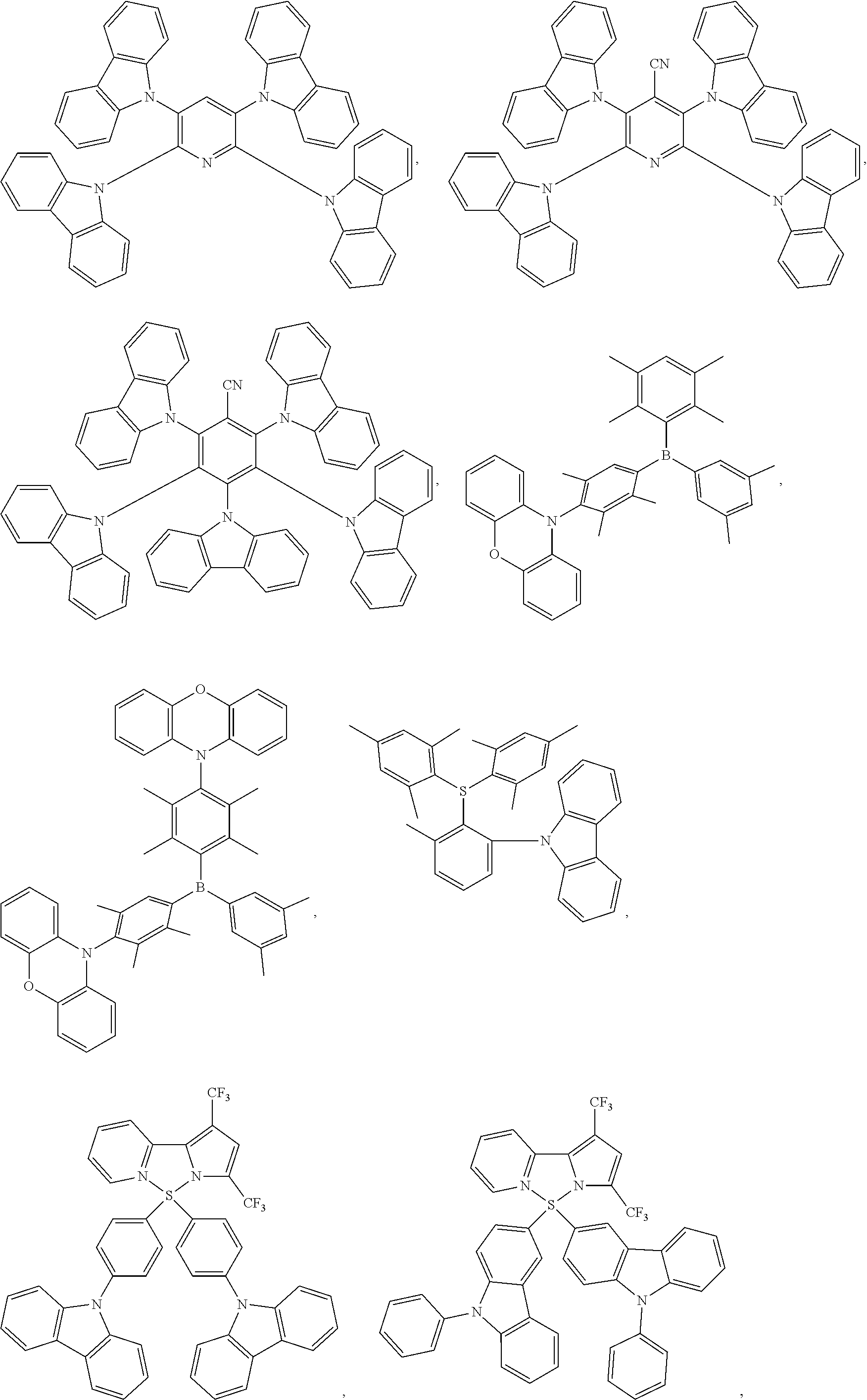

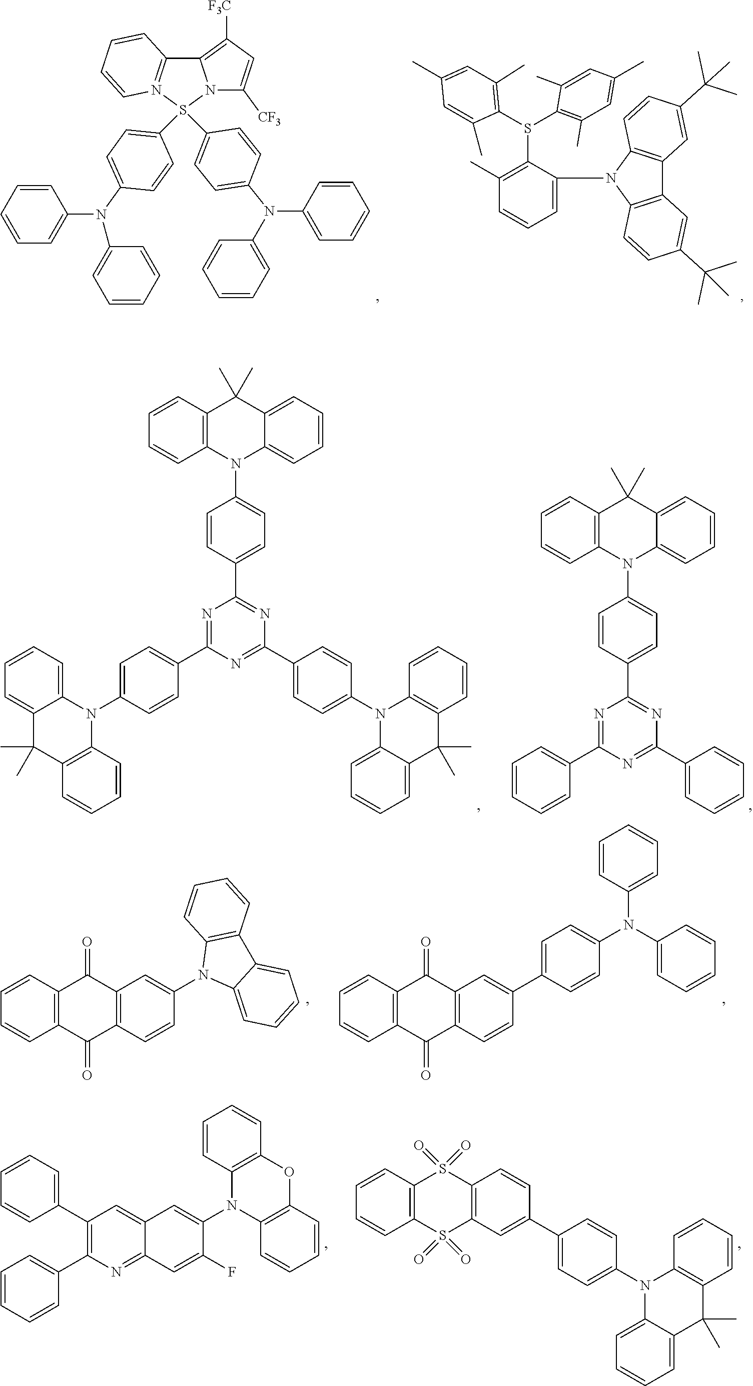

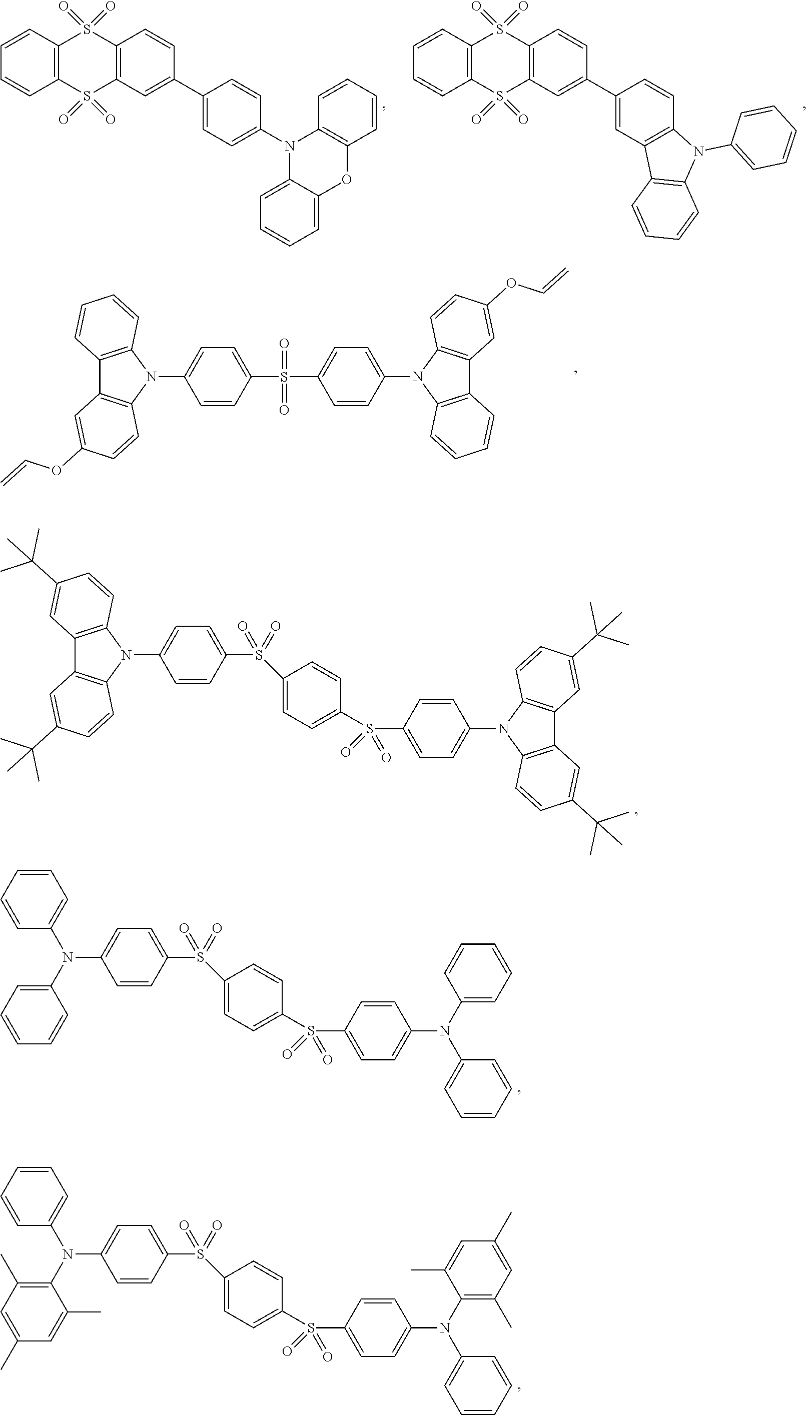

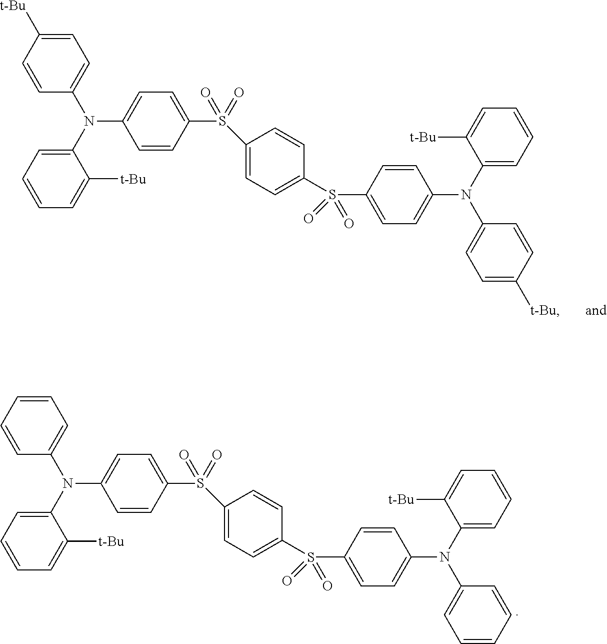 [SMILES: CC(C)(C)c1ccc(N(c2ccc(S(=O)(=O)c3ccc(S(=O)(=O)c4ccc(N(c5ccc(C(C)(C)C)cc5)c5ccccc5C(C)(C)C)cc4)cc3)cc2)c2ccccc2C(C)(C)C)cc1 ; CC(C)(C)c1ccccc1N(c1ccccc1)c1ccc(S(=O)(=O)c2ccc(S(=O)(=O)c3ccc(N(c4ccccc4)c4ccccc4C(C)(C)C)cc3)cc2)cc1]

For example, the host monomer can be

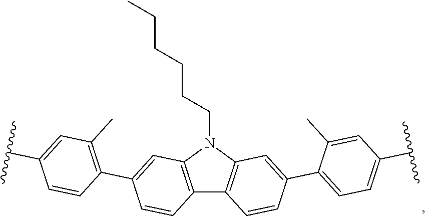 [SMILES: *c1ccc(-c2ccc3c4ccc(-c5ccc(*)cc5C)cc4n(CCCCCC)c3c2)c(C)c1]

the linker group can be R^{E}—C(CH₃)₂(CH₂)₂C(CH₃)₂—R^{E}, R^{E} can be

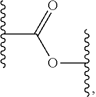 [SMILES: *OC(*)=O]

and the guest emitter can be

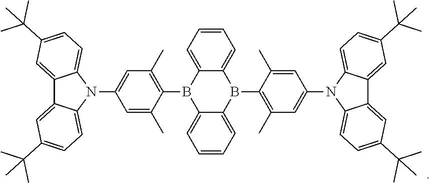 [SMILES: Cc1cc(-n2c3ccc(C(C)(C)C)cc3c3cc(C(C)(C)C)ccc32)cc(C)c1B1c2ccccc2B(c2c(C)cc(-n3c4ccc(C(C)(C)C)cc4c4cc(C(C)(C)C)ccc43)cc2C)c2ccccc21]

### Electron Acceptor Groups

In any of the polymers of the disclosure, the electron acceptor group can be any chemical group that can stabilize a negative charge and fluoresces when charged. For example, the electron acceptor group can be selected from

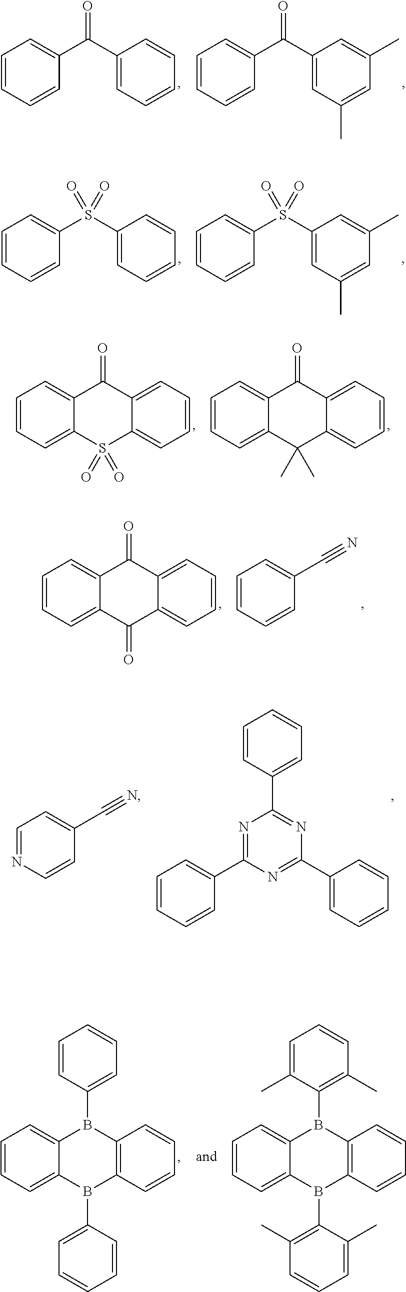

or selected from

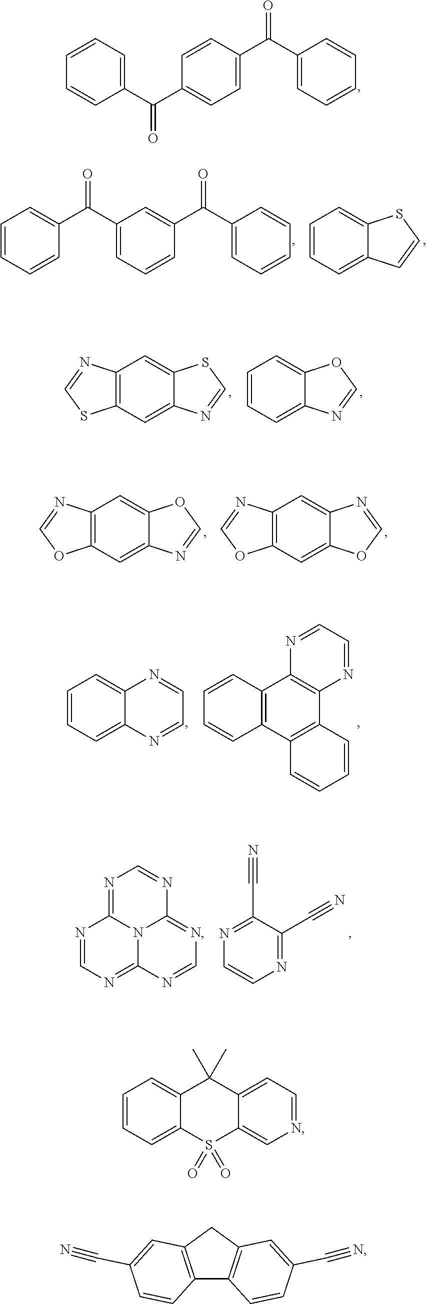

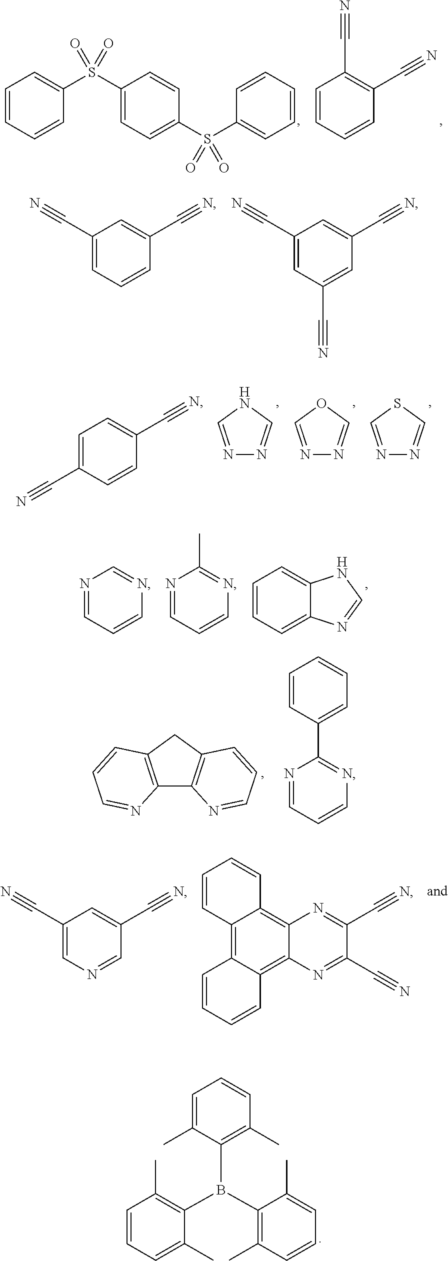

### Electron Donor Groups

In any of the polymers of the disclosure, the electron donor group can be any chemical group that can stabilize a positive charge and fluoresces when charged. For example, the electron donor group can be selected from

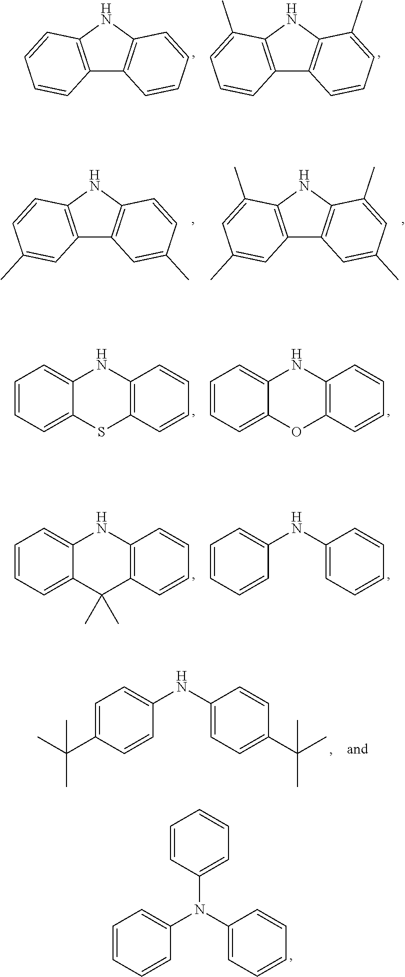

or selected from

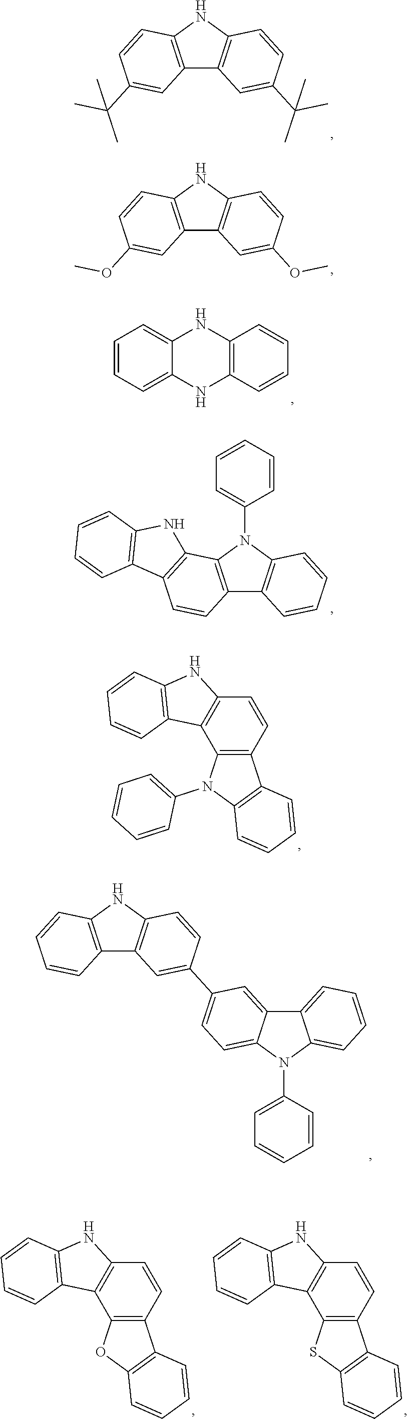

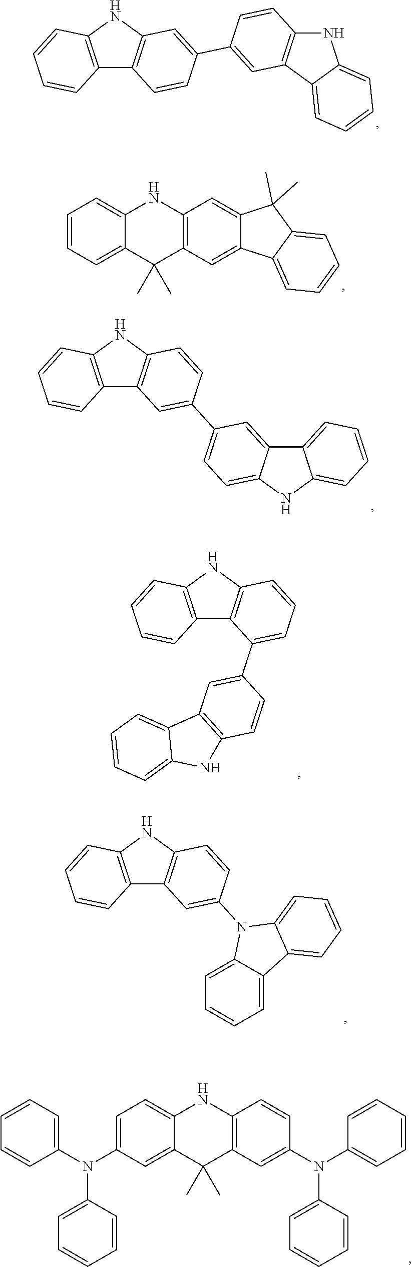

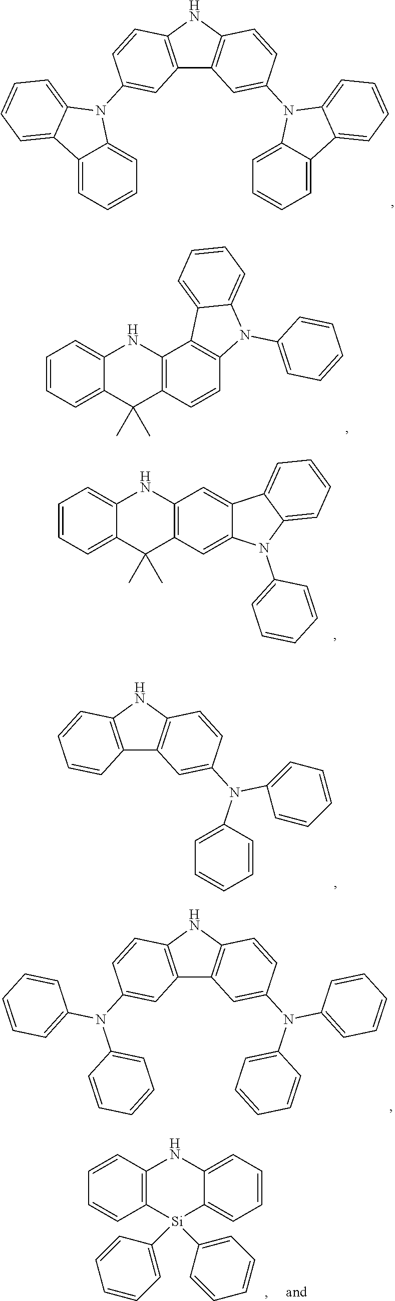

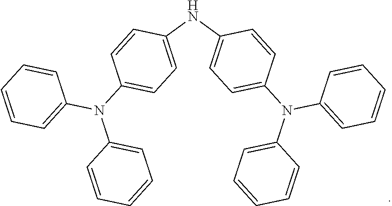 [SMILES: c1ccc(N(c2ccccc2)c2ccc(Nc3ccc(N(c4ccccc4)c4ccccc4)cc3)cc2)cc1]

### Linkers

In any of the polymers of the disclosure, the linker group can include one or more of R^{E}—(CH₂)ₙ—R^{E}, R^{E}—C(CH₃)₂(CH₂)ₙC(CH₃)₂—R^{E}, R^{E}—(CH₂CH₂O)ₙ—R^{E}, and R^{E}—(Si(CH₃)₂O)ₙ—R^{E}. For example, the linker group can be R^{E}—(CH₂)ₙ—R^{E}, R^{E}—C(CH₃)₂(CH₂)ₙC(CH₃)₂—R^{E}, or R^{E}—(CH₂CH₂O)ₙ—R^{E}. In each linker group n can be 1 or 2. R^{E} can be

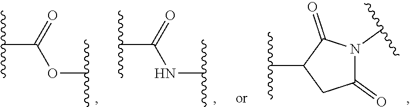

For example, R^{E} can be

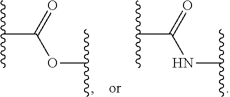 [SMILES: *OC(*)=O ; *NC(*)=O]

For example, the linker group can be R^{E}—(CH₂)ₙ—R^{E} or R^{E}—C(CH₃)₂(CH₂)ₙC(CH₃)₂—R^{E} and R^{E} is

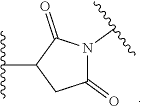 [SMILES: *C1CC(=O)N(*)C1=O]

The linker group provides a cleavable moiety that enables the polymers of the disclosure to depolymerize under mild acidic conditions and/or elevated temperatures. Additionally, the linker group can have greater stability under basic conditions, enabling its compatibility with a diverse range of polymerization reactions.

### Depolymerization of the Polymers of the Disclosure

As discussed above, the bonds broken during depolymerization of the polymers of the disclosure are different from the bonds formed during polymerization, thereby resulting in a breakdown of the polymer into monomers or segments. In any of the polymers of the disclosure, the linker group has R^{E} groups present at each end. The R^{E} groups attach the linker group to the aryl moiety of the polymer, through a carbon-carbon bond. The R^{E} groups also attach to the linker group, through a carbon-heteroatom bond, where the heteroatom is N or O.

During the polymerization step, the linker group is attached to the monomers by coupling the aryl moiety of the linker with the monomer. As a result, a carbon-carbon bond is formed between the aryl moiety of the linker groups and the monomers. During the depolymerization step, the carbon-heteroatom bond, where the heteroatom is N or O, is broken. Under acidic conditions and/or higher temperature, the carbon-heteroatom bond breaks and produces non-luminescent monomers or segments. Thus, while the aryl moiety was present on the linker group prior to polymerization, the aryl moiety is attached to the non-luminescent monomer after depolymerization. As a result of this structural change in the monomers, the luminescence is stopped.

### Chemical Definitions

As used herein, the term “alkyl” refers to straight chained and branched saturated hydrocarbon groups containing one to thirty carbon atoms, for example, one to twenty carbon atoms, or one to ten carbon atoms. The term Cₙ means the alkyl group has “n” carbon atoms. For example, C₄alkyl refers to an alkyl group that has 4 carbon atoms. C₁₋₆alkyl refers to an alkyl group having a number of carbon atoms encompassing the entire range (i.e., 1 to 6 carbon atoms), as well as all subgroups (e.g., 1-5, 2-5, 1-4, 2-5, 1, 2, 3, 4, 5, and 6 carbon atoms). Nonlimiting examples of alkyl groups include, methyl, ethyl, n-propyl, and isopropyl. Unless otherwise indicated, an alkyl group can be an unsubstituted alkyl group or a substituted alkyl group.

As used herein, the term “halo” is defined as fluoro, chloro, bromo, and iodo. Accordingly, a “haloalkyl” refers to an alkyl group substituted with one or more halo atoms.

### EXAMPLES

The following examples are provided for illustration and are not intended to limit the scope of the invention.

### Materials

(4-bromophenyl)(4-fluorophenyl) methanone, and 2,7-dibromo-9H-carbazole were purchased from Combi-Blocks INC. 9,9-dimethyl-9,10-dihydroacridine was purchased from Oakwood Products INC. 2,2′,2″-(1,3,5-Benzinetriyl)-tris(1-phenyl-1-H-benzimidazole) (TPBI) and Lithium fluoride (LiF) were purchased from Xian Polymer Light Technology Corp. PEDOT:PSS solution (CLEVIOS™ P VP CH 8000, 2.4-3.0 wt. % in water) was purchased from Heraeus Deutschland Gmbh & Co. KG and used without changing concentration. Patterned ITO glass substrate was purchased from Ossila Limited. Other general reagents and solvents were purchased from Sigma-Aldrich or Fisher Scientific.

### Methods

### Computational Simulations

All quantum chemical calculations were executed using the Gaussian 16 software. The molecular geometries were optimized in the ground state using the PBE0 functional with the 6-31G(d) basis set in the gas phase. TDDFT was applied to compute the lowest excited singlet and triplet states simulations, utilizing the optimized structures at the same level. For bond dissociation energy calculations, the same method as described in reference was used. (St John, P. C. et al. Sci. Data 7, 244 (2020)) The SMILES string of the repeating unit of PDKCE molecule was used to create the SMILES strings for radicals by iteratively breaking all single, non-ring bonds in the parent molecule. The resulting list of SMILES strings was canonicalized and de-duplicated using the open-source cheminformatics RDKit (http://www.rdkit.org). All the open and closed shell structures were initially relaxed for geometry optimization using B3LYP-D3/6-31G(d). Unrestricted Kohn-Sham DFT calculations of radicals were then performed with the M06-2X functional and def2-TZVP basis set with the default ultra-fine grid for all numerical integrations. M06-2X/def2-TZVP was previously found to have a favorable trade-off between experimental accuracy and computational efficiency.

### Characterization

Nuclear Magnetic Resonance spectroscopy (NMR) was performed on Bruker Ultra Shield 500M NMR Spectrometer. High resolution Mass spectroscopy (MS) was performed on Thermo Fisher orbitrap classic mass spectrometer. Number average molecular weight (Mₙ), weight average molecular weight (M_{w}), and polydispersity index (PDI) were evaluated by Agilent HT-GPC system with THE as fluid phase at temperature of 40° C. Absorption was measured using Shimadzu UV-3600 Plus UV-VIS-NIR spectrophotometer.

The photoluminescence (PL) spectra were measured with Horiba Spectrofluorometer-Fluorolog 3. Time-resolved emission experiments were performed on samples loaded in a nitrogen cryostat which was evacuated. Time-resolved emission was performed by exciting the sample with ultraviolet pulses prepared by directing the output of a 35 fs Ti:sapphire laser into an optical parametric amplifier, with emission monitored using a streak camera. The PL quantum yield (PLQY) and low-temperature FL/PH spectra were measured using LSM Series High-Power LED (310 nm, Ocean Optics) as the light source and a fiber integration sphere (FOIS-1) coupled with a QE Pro spectrometer (Ocean Optics) as the spectrometer. The samples were held on a homemade stage to enable the light source excited on the samples, and the emitted light was collected with the integration sphere. The samples are measured in liquid N2 for Low-temperature FL/PH spectra.

Thermogravimetric analysis (TGA) and differential scanning calorimeter (DSC) are measured by Mettler Toledo TGA/STGA851e and Mettler Toledo DSC823e, respectively. Cyclic voltammetry was performed on a Multi PalmSens4 electrochemical analyzer with 0.1 M tetra-n-butylammonium hexafluorophosphate (Bu₄NPF₆) as a supporting electrolyte, a saturated calomel electrode (SCE) as a reference electrode, a Pt disk as a working electrode, and a scan rate of 50 mV/s in dimethylformamide (DMF). The oxidation potential of SCE relative to the vacuum level was calibrated to be 4.662 V in DMF.

Printed QR-code patterns were printed on glass substrates by Optomec Aerosol Jet 5X system. The degradable green pattern was created using an ink of PDKCE with a concentration of 2 mg/mL, dissolved in a 9:1 mixture of chlorobenzene and N-methyl-2-pyrrolidone. The center pattern was printed with the ink of PDKCE (2 mg/mL) for green, PC6E (5 mg/mL) for blue, 1:1 of PC6E and TPA-AQ (3 mg/mL) for red, which were separately dissolved in a 9:1 mixture of chlorobenzene and N-methyl-2-pyrrolidone. (Liu, W. et al., Nat. Mater. 2023; doi:10.1038/s41563-023-01529-w)

### OLED Fabrication and Testing

The ITO-coated glasses were first cleaned with 1 vol. % Hellmanex solution, isopropyl alcohol (IPA), deionized (DI) water, and then dried and further treated with O₂ plasma (150 W, 10 min.). PEDOT:PSS dispersion was spin-coated on ITO substrates at 4,500 rpm for 1 min as hole injection/hole transporting layer (HIL/HTL), followed by annealing at 150° C. for 30 min. Then, the emitting layers (EML) were spin-coated in the glovebox from the polymer solutions of 8 mg/mL in CB. The spin-coating condition is 1,500 rpm for 30 s, which is followed by annealing at 100° C. for 15 min. Next, thermal evaporations were carried out to sequentially deposit TPBI as the electron-transporting layer, LiF as the electron-injection layer, and Al as the cathode electrode, with the corresponding deposition rates of 1, 0.1, and 10 Å s⁻¹, respectively.

Current density-voltage-luminance (J-V-L) measurements were carried out at room temperature with a Keithley 2450 source meter, and a fiber integration sphere (FOIS-1) coupled with a QE Pro spectrometer (Ocean Optics) in an N₂ filled glovebox. The OLED devices were tested on top of the integrating sphere, where only forward light emission can be collected. The absolute OLED emission was calibrated by a standard visible-NIR light source (HL-3P-INT-CAL plus, Ocean Optics).

### Example 1—Synthesis of Polymers of the Disclosure

### Synthesis of Linker Groups for Polymers of the Disclosure

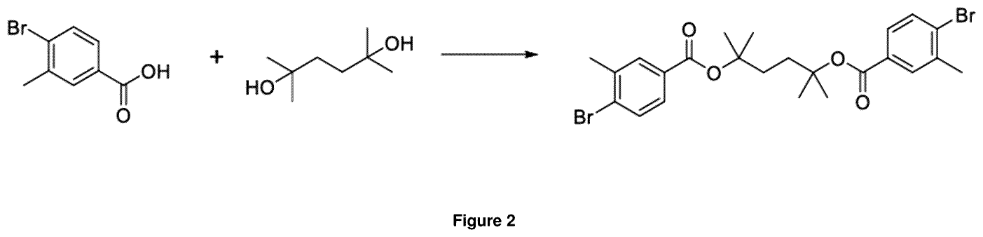

The linker group was synthesized via coupling of a halogenated benzoic acid compound with tert-butyl ester, as shown in FIG. 2.

A mixture of 4-bromo-3-methylbenzoic acid (10 mmol, 2.15 g), 2,5-dimethylhexane-2,5-diol (5 mmol, 0.73 g), and 4-dimethylaminopyridine (DMAP) (3.5 mmol, 0.43g) in tetrahydrofuran (THF) (50 mL) was stirred at room temperature for about 15 min. Then, N,N′-diisopropylcarbodiimide (DIC) (12 mmol, 1.51 g) was added and the reaction was stirred for 3 days. The reaction solution was filtered to remove the urea by-product and concentrated under vacuum. The crude was then purified by silica gel column chromatography eluting with hexane: ethyl acetate (10:1), to provide 1 as a white solid (0.56 g, 1.04 mmol, 21%). ¹H NMR (400 MHz, CDCl₃) δ 7.75 (d, J=1.8 Hz, 2H), 7.54 (dd, J=8.3, 2.0 Hz, 2H), 7.47 (d, J=8.3 Hz, 2H), 2.33 (s, 6H), 1.92 (s, 4H), 1.49 (s, 12H).

### Synthesis of Electron Acceptor and Donor Groups for Polymers of the Disclosure

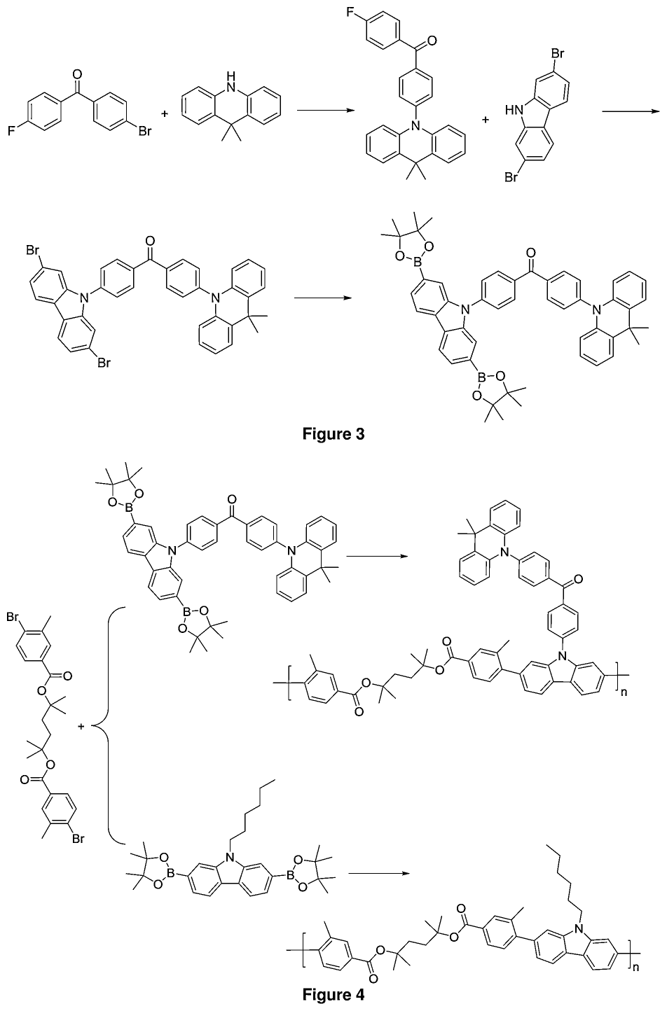

The TADF units were constructed by acridine and benzophenone as electron acceptor and donor groups, respectively. These are attached as pendant side groups to carbazole groups in the polymer backbone, as shown in FIG. 3.

Step 1. Under a N₂ atmosphere, toluene (20 mL) was added to a mixture of (4-bromophenyl)(4-fluorophenyl)methanone (1.1 g, 4 mmol), 9,9-dimethyl-9, 10-dihydroacridine (0.81 g, 4 mmol), bis(dibenzylideneacetone)dipalladium (Pd(dba)₂) (0.115 g, 0.2 mmol), sodium tert-butoxide (NaO^{t}Bu) (0.96 g, 10.0 mmol), and dicyclohexylphosphino-2,4,6-tri-i-propyl-1,1-biphenyl (Xphos) (0.28 g, 0.6 mmol) and the mixture was refluxed for 12 h. After, the mixture was cooled to room temperature and extracted using dichloromethane (DCM) and distilled water. The organic phase was dried over Na₂SO₄, filtered, and the solvent was removed. The crude material was purified via column chromatography on silica gel using hexane/DCM (v/v=4:1) as eluent to provide 2 (yellow powder, 1.28 g, yield 81%). ¹H NMR (400 MHz, CDCl₃) δ 8.07-8.01 (m, 2H), 8.00-7.92 (m, 2H), 7.54-7.44 (m, 4H), 7.25-7.19 (m, 2H), 7.05-6.92 (m, 4H), 6.33 (dd, J=8.0, 1.4 Hz, 2H), 1.70 (s, 6H).

Step 2. A mixture of 2 (1.22 g, 3 mmol) and 2,7-dibromo-9H-carbazole (1.03 g, 3.2 mmol) in N,N-dimethylformamide (DMF) (15 mL) was stirred for 15 min under Ar (g) at room temperature, and then the reaction mixture was heated up to 110° C. and potassium tert-butoxide (KO^{t}Bu) (0.35 g, 3.1 mmol) was added and stirred for 12 h. The reaction was quenched with water (20 mL), and precipitated in methanol, filtered by vacuum, and washed with methanol three times to obtain 3 (yellow powder, 2.01 g, yield 90%). ¹H NMR (400 MHz, CDCl₃) δ 8.19 (dd, J=12.4, 8.3 Hz, 4H), 7.97 (d, J=8.3 Hz, 2H), 7.73 (d, J=8.3 Hz, 2H), 7.63 (d, J=1.6 Hz, 2H), 7.56 (d, J=8.2 Hz, 2H), 7.50 (dd, J=7.7, 1.6 Hz, 2H), 7.45 (dd, J=8.3, 1.6 Hz, 2H), 7.02 (tdd, J=14.9, 10.5, 4.6 Hz, 4H), 6.39 (d, J=8.0 Hz, 2H), 1.71 (s, 6H).

Step 3. 3 (1.42 g, 2 mmol), bis (pinacolato) diboron (1.52 g, 6 mmol), [1,1 Bis(diphenylphosphino)ferrocene]dichloropalladium(II) (73 mg, 0.1 mmol) and potassium acetate (0.59 g, 6 mmol) were mixed, then placed under vacuum and flushed with N₂ for 3 cycles. Next, degassed DMF (15 mL) was added, and the system was heated to 100° C. overnight. Then, the mixture was cooled down to room temperature and precipitated into a saturated sodium chloride solution (100 mL), filtered by vacuum to obtain the crude product, purified by column chromatography on silica gel (short ˜15 cm) using hexane/DCM=1:3, and then DCM as eluent to give 4 (yellow powder, 0.81 g, yield 50.1%). ¹H NMR (400 MHz, CDCl₃) δ 8.29-8.13 (m, 6H), 7.95 (s, 2H), 7.80 (t, J=7.8 Hz, 4H), 7.56 (d, J=8.4 Hz, 2H), 7.49 (d, J=7.7 Hz, 2H), 7.01 (dt, J=13.7, 7.3 Hz, 4H), 6.38 (d, J=7.0 Hz, 2H), 1.72 (s, 6H), 1.36 (s, 24H).

### Synthesis of Polymers of the Disclosure

A depolymerizable TADF polymer (namely PDKCE) with tert-butyl ester bonds and TADF units in the polymer mainchain was synthesized as shown in FIG. 4. A host polymer (namely PC6E) with tert-butyl ester bonds and non-TADF monomers was synthesized as well and is also shown in FIG. 4.

Pinacolato-boron monomer (0.7 mmol), bromine monomer (0.7 mmol), tris (dibenzylideneacetone) dipalladium (2 mg), and 2-dicyclohexylphosphino-2,6-dimethoxybiphenyl (SPhos) (7 mg) were charged into a microwave reaction vessel and sealed in the glove box with a balloon. Degassed toluene (5 mL) was added, and the mixture was heated to 65° C. under vigorous stirring in a bath heater for 3 min. A degassed potassium carbonate solution (5 mL, 2 mol/L in water) with four drops of Aliquat 336 was added. Then balloon was removed, and the vessel was heated at 85° C. in the microwave reactor for 1 h 45 min. After the polymerization, phenylboronic acid and bromobenzene were sequentially added as capping agents and further reacted for 3 min at 85° C. for each. After, the mixture was cooled down to room temperature and poured into DCM (100 mL) and washed with saturated sodium chloride solution (100 mL) five times. The separated organic layer was dried over Na₂SO₄ and concentrated to 8 mL. The mixture was precipitated into 200 mL methanol and filtered to obtain the crude product. The product was purified by Soxhlet extraction with boiling methanol, acetone, and chlorobenzene. The product-containing solution was concentrated to 5 mL, precipitated into 200 mL methanol, and filtered to obtain the polymers, PDKCE and PC6E.

PDKCE: ¹H NMR (500 MHz, CDCl₃) δ 8.19 (d, J=8.0 Hz, 2H), 8.16-8.04 (m, 4H), 7.92 (d, J=1.7 Hz, 2H), 7.86 (dd, J=7.9, 1.7 Hz, 2H), 7.82-7.75 (m, 2H), 7.52-7.41 (m, 6H), 7.39-7.20 (m, 7H), 7.02-6.89 (m, 4H), 6.32 (dd, J=7.9, 1.6 Hz, 2H), 2.36 (s, 1H), 2.34 (s, 6H), 2.05 (s, 4H), 1.66 (s, 6H), 1.59 (s, 12H). GPC: Mn=59.4 kDa, Mw=105.0 kDa, PDI=1.8.

PC6E: ¹H NMR (500 MHz, CDCl₃) δ 8.12 (d, J=8.0 Hz, 2H), 7.97 (d, J=1.8 Hz, 2H), 7.91 (dd, J=7.8, 1.7 Hz, 2H), 7.42 (d, J=7.9 Hz, 2H), 7.35-7.27 (s, 2H), 7.18 (dd, J=7.9, 1.3 Hz, 2H), 4.28 (s, 2H), 2.37 (s, 6H), 2.10 (s, 4H), 1.85 (p, J=7.2 Hz, 2H), 1.64 (s, 12H), 1.42-1.34 (m, 2H), 1.34-1.18 (m, 4H), 0.80 (t, J=7.0 Hz, 3H). GPC: Mn=22.7 kDa, Mw=37.2 kDa, PDI=1.6.

### Example 2—Characterization of Degradable Polymers of the Disclosure

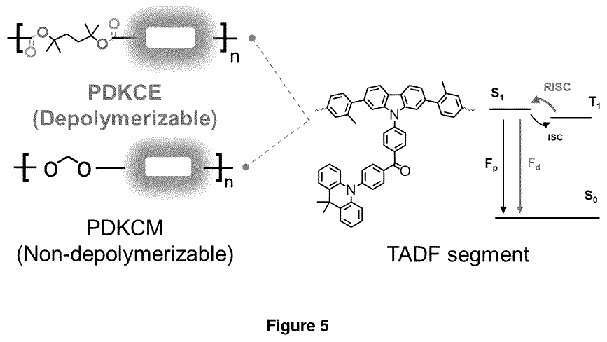

To investigate the impact of incorporating cleavable TB-ester bonds on TADF properties, a control polymer (PDKCM) containing a non-depolymerizable methyl-ether group and identical TADF units was synthesized for comparison. (FIG. 5) Notably, these methyl-ether linker groups have been shown to have no discernible influence on TADF properties. (Liu, W. et al., Nat. Mater. 2023; doi:10.1038/s41563-023-01529-w)

### Computational Simulation

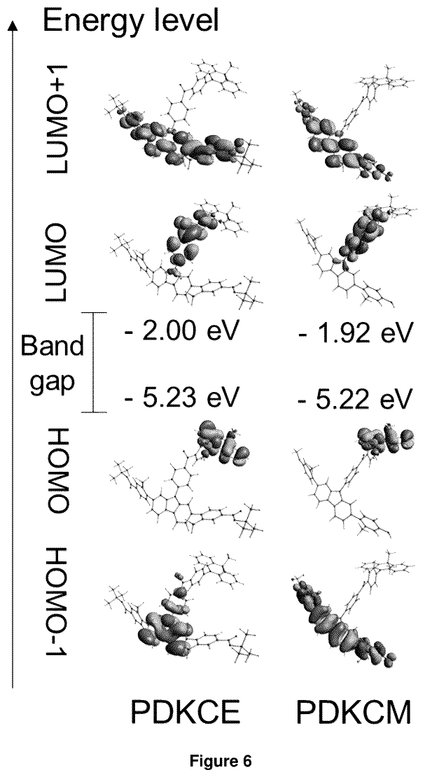

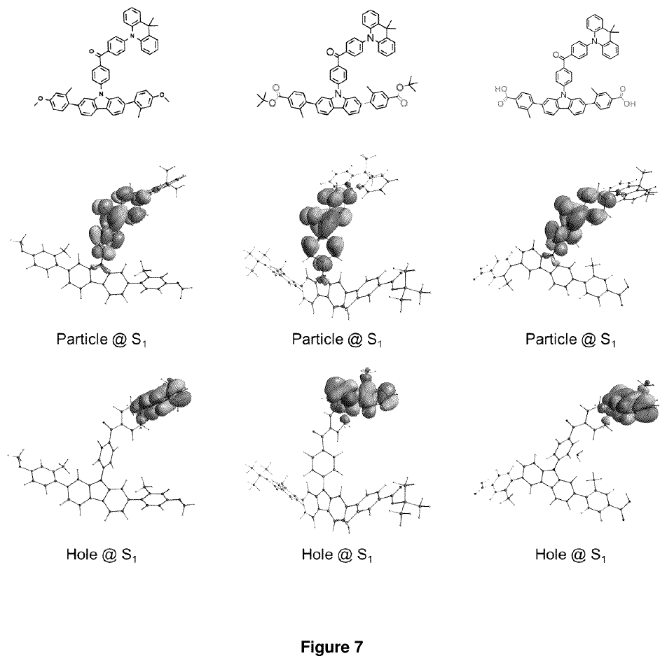

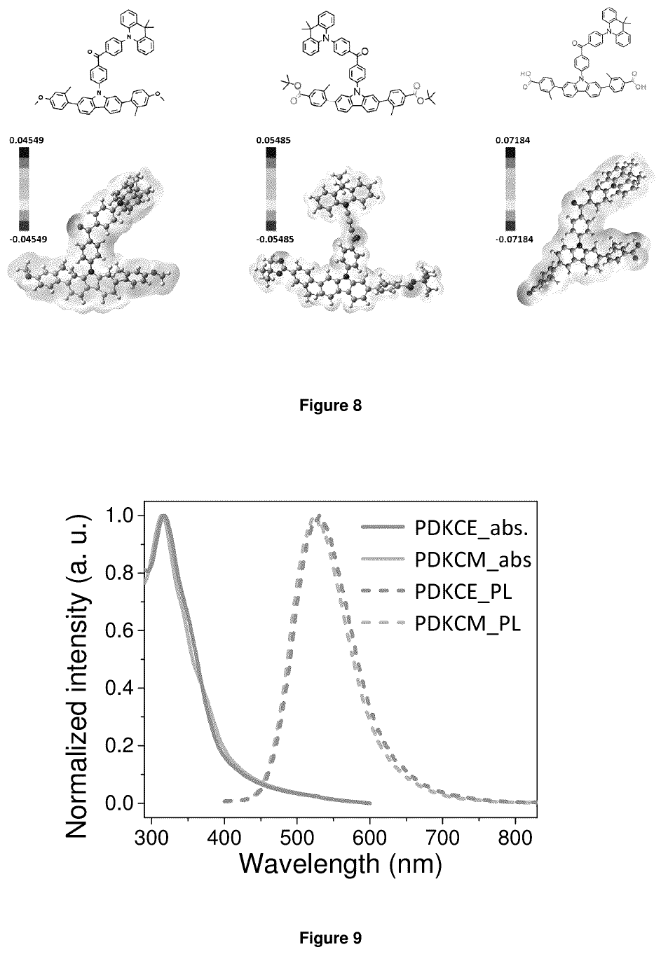

To study the effects of TB-ester functionality of the TADF polymer on its light-emitting property, density functional theory (DFT) based calculations were first performed to reveal the band structures. Since the alkyl chains break the conjugation in the backbone, DFT calculations were performed on the repeating unit as it is reasonable to assume that the photophysical properties and electronic structures of TADF polymers will be largely determined by the smallest conjugation units as shown in FIGS. 6 and 7. The calculations showed that in PDKCE, the highest occupied molecular orbital (HOMO) and lowest unoccupied molecular orbital (LUMO) are respectively localized on the electron donor and acceptor groups, respectively. Notably, these molecular orbitals have little overlap, and the dihedral angle between the electron donor and acceptor planes remains orthogonal at 89.9° without much change resulting from the introduction of the TB-ester moieties, as shown in FIG. 6. These results suggest that PDKCE possesses a small ΔE_{ST}, which enables the efficient RISC of excitons from the triplet state to the singlet state for TADF emission. As a comparison, similar results were observed in the control polymer, PDKCM. However, in PDKCM, the HOMO−1 distribution extends from the carbazole group to the ether group, while in PDKCE, it is confined to the carbazole group. Conversely, the LUMO+1 distribution stretched further away from the carbazole group onto the TB-ester groups in PDKCE. This notable difference can be attributed to the higher electron-deficient property of the TB-ester group compared with the ether group, shown in FIG. 8.

### Photophysical Analysis

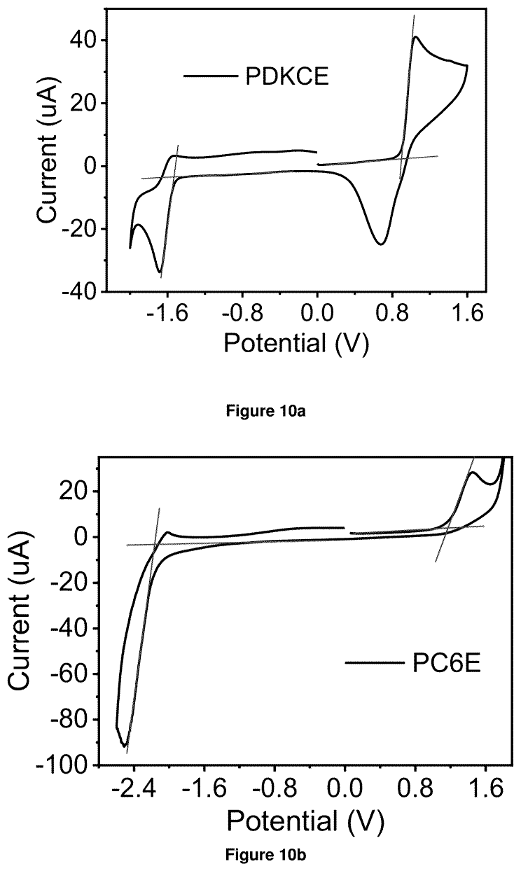

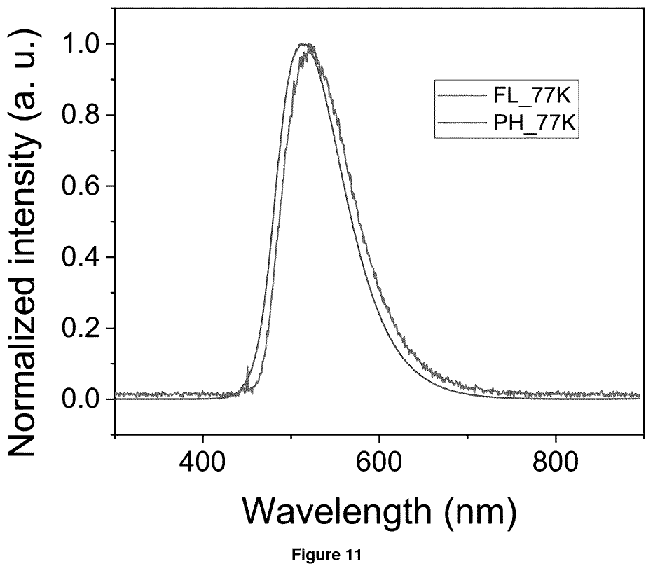

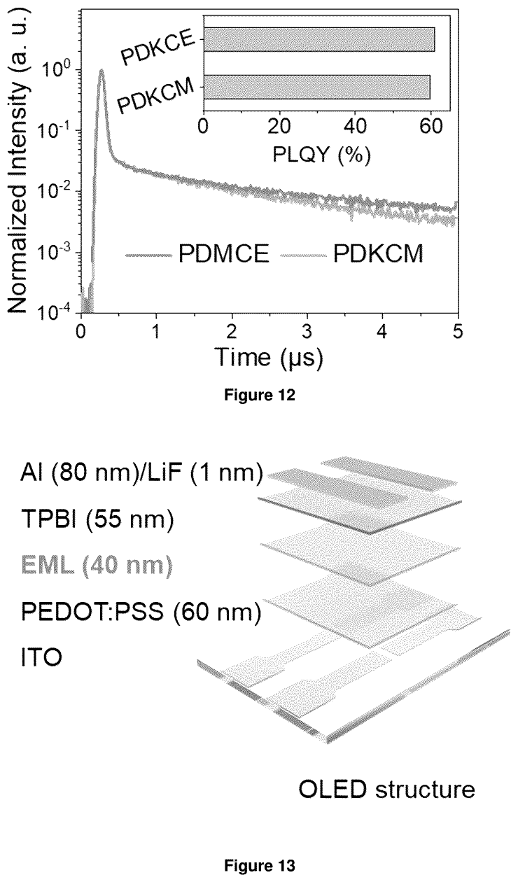

The impact of the TB-ester moieties on the PL properties was further investigated by conducting a more detailed photophysical study of PDKCE and the control polymer PDKCM. PDKCE and PDKCM produce very similar ultraviolet-visible (UV-vis) absorption and PL spectra at room-temperature (FIG. 9), in agreement with electrochemical cyclic voltammetry test results (FIGS. 10a and 10b), and DFT calculations (FIG. 6). Firstly, the ΔE_{ST} was estimated by the difference between the onset of low-temperature (77K) FL/PH spectra (FIG. 11), revealing that PDKCE keeps a sufficiently small ΔE_{ST} of 0.05 eV, which is very close to that of PDKCM. (Liu, W. et al., Nat. Mater. 2023; doi:10.1038/s41563-023-01529-w) At room temperature, the PL quantum yield (PLQY) of PDKCE reaches 60%, which is composed of both prompt and delayed fluorescence as evidenced by the transient PL decay tests (FIG. 12). Once again, these aspects are highly similar to those of PDKCM, indicating that the TB-ester bond has a limited impact on the overall TADF process.

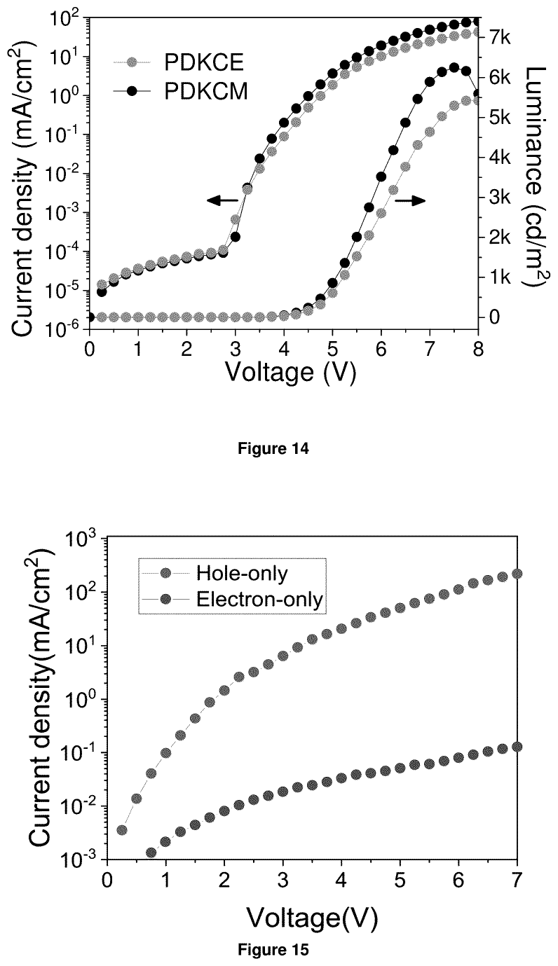

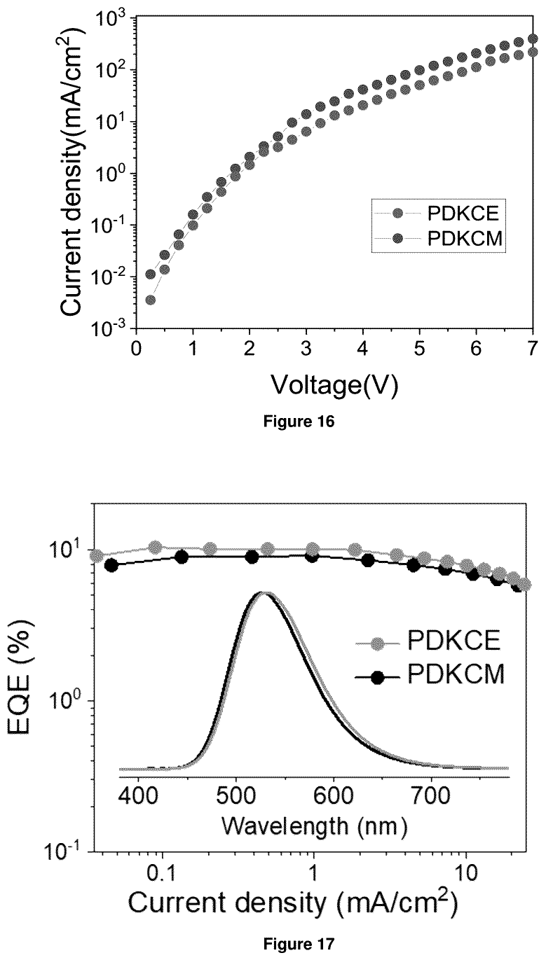

Subsequently, the EL properties of PDKCE were investigated. In particular, the OLED performance of PDKCE was studied as a host-free EML in a conventional OLED structure (FIG. 13). As a comparison, PDKCM was fabricated into the same OLED structure. As shown by the current density-voltage (J-V) and luminance-voltage (L-V) traces, PDKCE only exhibits a minor decrease in the current density and luminance compared to PDKCM at the same voltage (FIG. 14). Since the HOMO/LUMO levels are similar for the two polymers, the small difference might be caused by the slightly decreased charge mobility, which was confirmed through the fabrications and measurements of their hole-only devices (FIGS. 15 and 16). Additionally, a slight redshift in the EL spectrum for PDKCE was observed, although little differences were observed for the turn-on voltage and maximum EQE values (FIG. 17). It is noteworthy that the achieved EQE of 10.4% from PDKCE-OLED is at least ˜7 times higher than previously reported depolymerizable light-emitting polymers. (Al-Attar, H. et al., Polym. Int. 70, 51-58 (2020))

### Example 3—Depolymerization of the Degradable Polymer

The depolymerizability of the PDKCE was studied using two different stressors: acid and heat.

### Acidic Depolymerization

PDKCE and PDKCM (3 mg) were separately dissolved in THF to generate 5 mg/mL solutions with sonication. 8 μL of a 35% HCI solution was added for every 1 mL of THE solution. The solution was mixed thoroughly and heated to 50° C. Then, 100 μL of the solution was diluted into 1 mL of THF and filtered for GPC sample preparation. GPC analysis was performed at room temperature with freshly prepared samples.

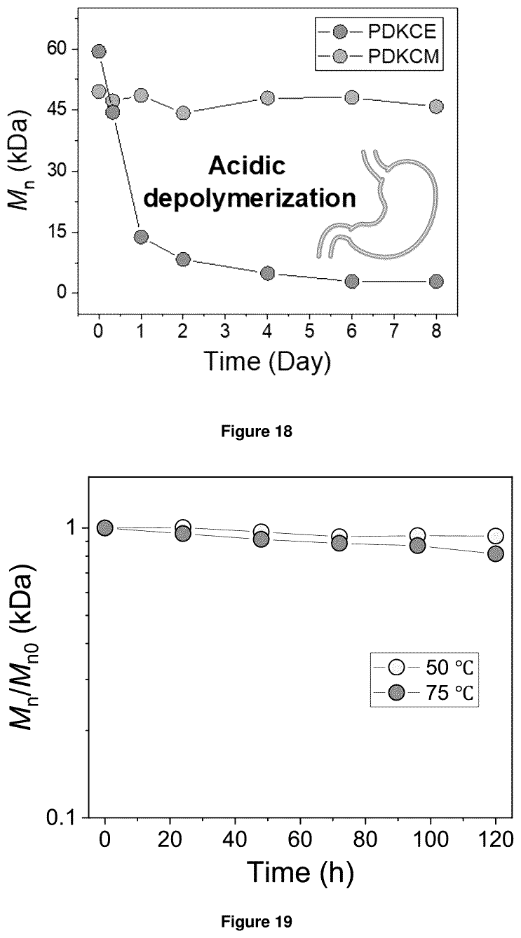

The PDKCE chain can be effectively deconstructed by over 90% in a near-stomach-acid condition (i.e., pH=1.2) within 4 days. (Lei, T. et al., Proc. Natl. Acad. Sci. U. S. A. 114, 5107-5112 (2017)) As measured by the gel permeable chromatography (GPC), a decrease in the average number of molecular weights was observed, indicating its potential in bio-applications (FIG. 18). (Kong, D. et al., Adv. Mater. Technol. 7, 2100006 (2021); Boutry, C. M. et al. Nat. Biomed. Eng. 3, 47-57 (2019); Reeder, J. T. et al. Science 377, 109-115 (2022); Zarei, M. et al. Adv. Mater.35, e2203193 (2022)) In comparison, the control polymer PDKCM showed no depolymerization under the same conditions. Furthermore, PDKCE demonstrated remarkable stability in harsh basic conditions, demonstrating the compatibility of TB-ester with the conditions required for its synthesis procedure, such as the general polymerization procedure described above (FIG. 19).

### Thermal Depolymerization

PDKCE and PDKCM (3 mg) were transferred onto a pre-balanced TGA sample pan and placed in the TGA instrument under a stream of N₂ gas with a flowrate of 20 mL/min. The TGA instrument was heated to 250° C. with a heating rate of 15° C./min, and the temperature was maintained at 250° C. for 60 min to provide the degraded polymer.

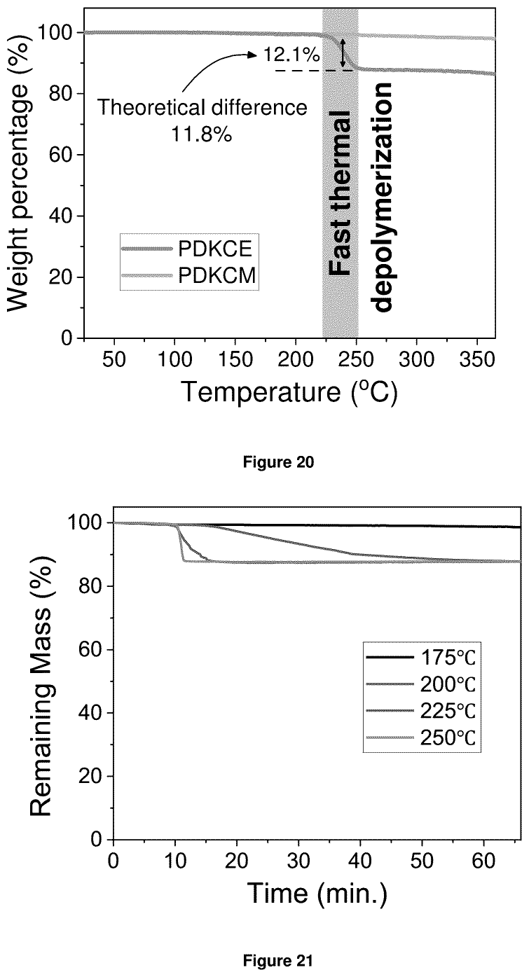

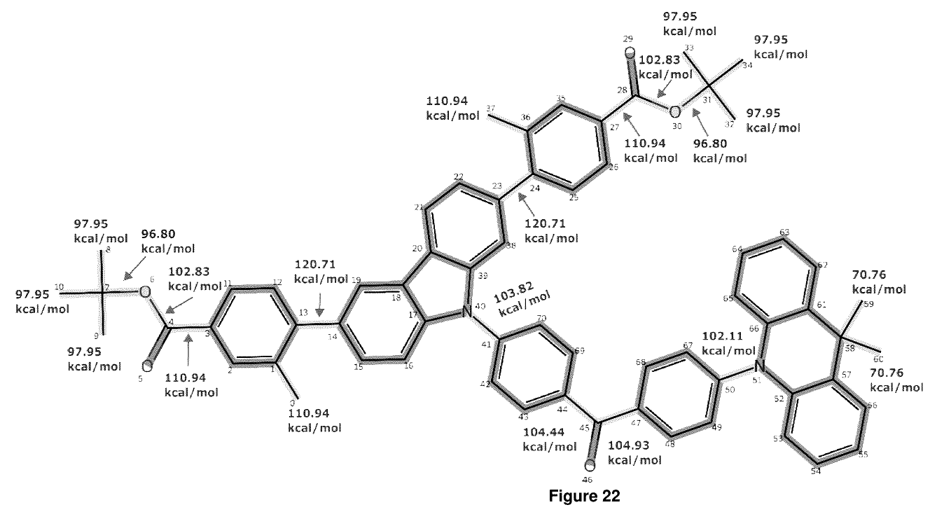

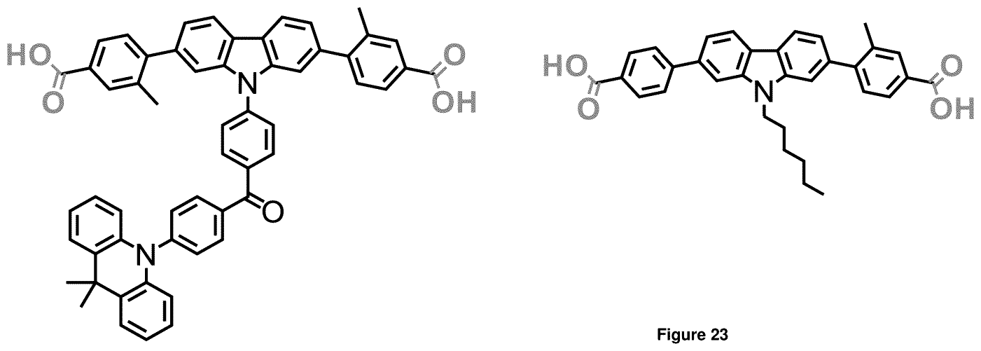

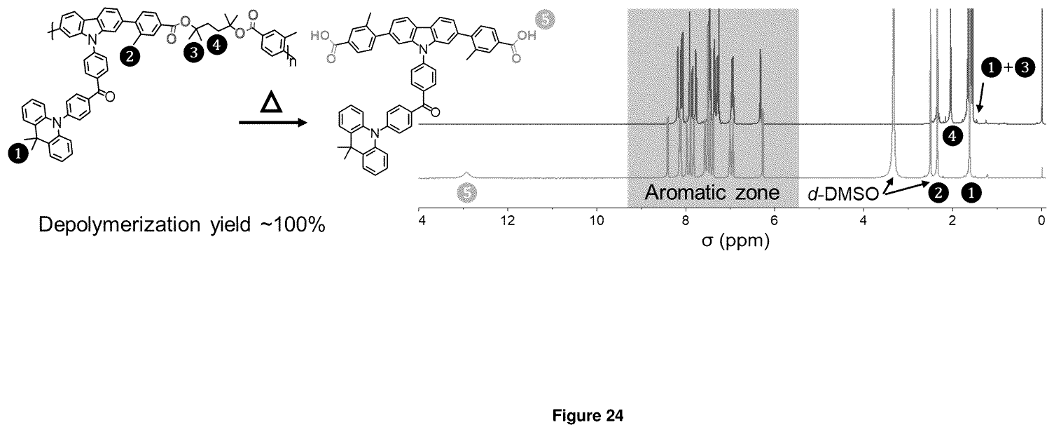

Thermal gravity analysis (TGA) shows that PDKCE remains stable up to 210° C., after which a swift mass loss occurs between 210 to 250° C., indicating depolymerization as shown in FIG. 20. The depolymerization rate of PDKCE can be finely controlled by selecting different depolymerization temperatures, as shown in FIGS. 21 and 22. The mass loss of 12.1% in TGA is almost equivalent to the theoretical weight value of 11.8% needed for PDKCE to generate the di-carboxylic acid group-capped monomers (FIG. 20). Moreover, DFT calculations confirm that the TB-ester along the polymer backbone has relatively weak bond energy by mapping the bond dissociation enthalpy for the smallest conjugation units (FIG. 23). (St John, P. C. et al. Sci. Data 7, 244 (2020)) Further analysis of the crude product of PDKCE from thermal depolymerization using nuclear magnetic resonance (NMR) and high-resolution mass spectroscopy shows that the depolymerization yields diacid monomers in very high purity without requiring any purification (FIGS. 24, 25a, 25b, 26a, and 26b). In contrast, no depolymerization behavior can be observed for PDKCM in this entire temperature range (FIG. 20).

### Esterification of Depolymerized Polymers of the Disclosure

A mixture of 4,4-(9-(4-(4-(9,9-dimethylacridin-10(9H)-yl)benzoyl)phenyl)-9H-carbazole-2,7-diyl)bis(3-methylbenzoic acid) (depolymerized monomer from PDKCE) (0.018mmol, 15 mg), 4-dimethylaminopyridine (DMAP) (0.066 mmol, 8 mg), and 1-Ethyl-3-(3-dimethylaminopropyl)carbodiimide hydrochloride (EDC·HCl) (0.063 mmol, 12 mg) was transferred to 10 mL Schlenk flask. The flask was connected to a Schlenk line and switched between vacuum and N₂ 3 times to generate the inert environment. Afterward, 2 mL dry tetrahydrofuran (THF) and 10 μL methanol was added sequentially via syringe, and the system was stirred at room temperature for 14 h. After, the mixture was extracted with chloroform and distilled water 3 times. The chloroform phase was dried over Na₂SO₄, filtered, and the solvent was removed. The product was purified by column chromatography on silica gel using hexane/chloroform (v/v=1:4) as eluent to give the product (12 mg, yield 77%).

¹H NMR (500 MHz, CDCl₃) δ 8.23 (d, J=8.0 Hz, 2H), 8.14 (dd, J=19.0, 8.4 Hz, 4H), 7.98 (s, 2H), 7.91 (dd, J=7.9, 1.6 Hz, 2H), 7.81 (d, J=8.5 Hz, 2H), 7.55-7.46 (m, 6H), 7.39 (d, J=7.9 Hz, 2H), 7.32 (dd, J=8.0, 1.3 Hz, 2H), 7.06-6.94 (m, 4H), 6.35 (dd, J=7.9, 1.4 Hz, 2H), 3.94 (s, 6H), 2.37 (s, 6H), 1.69 (s, 6H).

¹³C NMR (126 MHz, CDCl₃) δ 194.56, 167.13, 146.97, 140.67, 140.46, 139.50, 136.60, 135.84, 132.60, 132.06, 131.57, 130.86, 130.17, 129.01, 127.00, 126.43, 125.37, 122.79, 122.12, 121.22, 120.27, 114.49, 110.24, 77.28, 77.03, 76.78, 52.15, 36.12, 31.03, 29.72, 20.65.

### Characterization of the Degraded Polymer

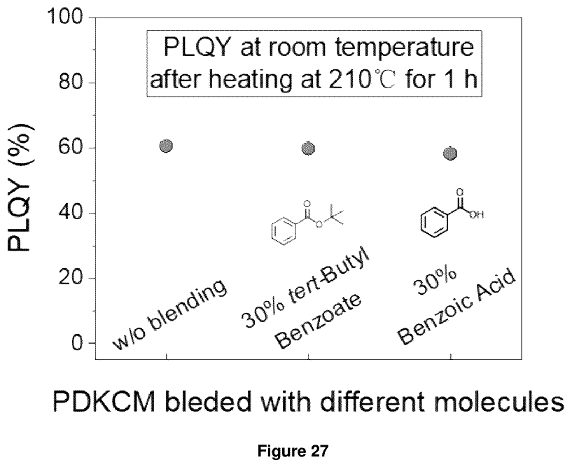

The influence of tert-butyl and carboxylic acid groups was studied by blending tert-butyl benzoate and benzoic acid with PDKCM, respectively. PLQY measurements (FIG. 27) showed that the mere presence of carboxylic acid groups or tert-butyl ester groups alone do not produce the decrease in PLQY after depolymerization with PDKCE.

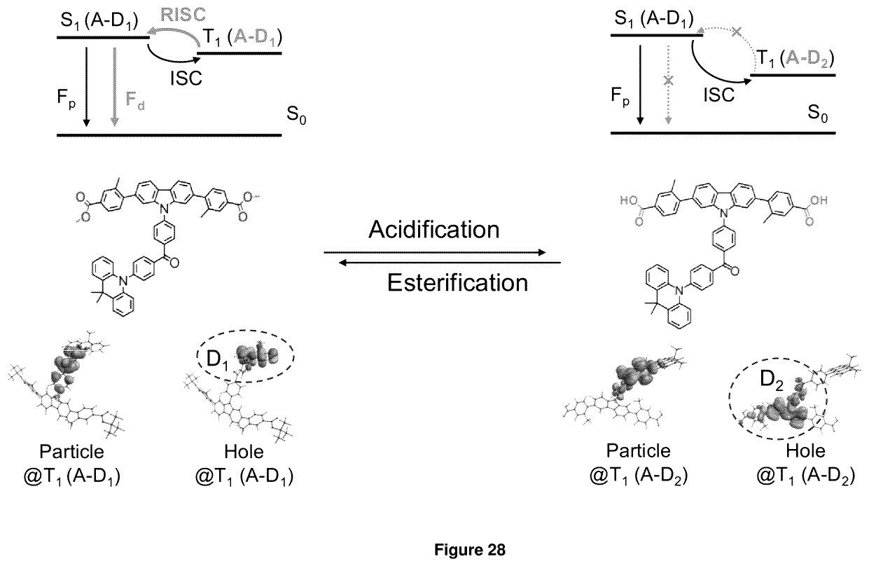

DFT calculations showed that HOMO/LUMO distributions at the S₀ state and hole/particle distributions at S₁ state are very similar before and after depolymerization, which produced an unchanged charge transfer state in the benzophenone-acridine (A-D₁) pair (FIGS. 6 and 7). However, the carboxylic acid groups caused the T₁ state to shift from the A-D₁ pair to the benzophenone-carbazole (A-D₂) pair after depolymerization (FIG. 28), which was caused by the electron deficient property of the carboxylic acid groups, compared to the TB-ester bonds (FIG. 8). The substantial overlap of the hole/particle distributions suggests that this T₁ state is notably lower than the S₁ state, resulting in a large ΔE_{ST} and causing the deactivation of TADF due to inefficiency of the RISC process (FIG. 28). This mechanism was confirmed by esterification of the depolymerized product derived from PDKCE (non-luminescent), which restored the TADF process, i.e., restored the luminescence as shown in FIG. 28.

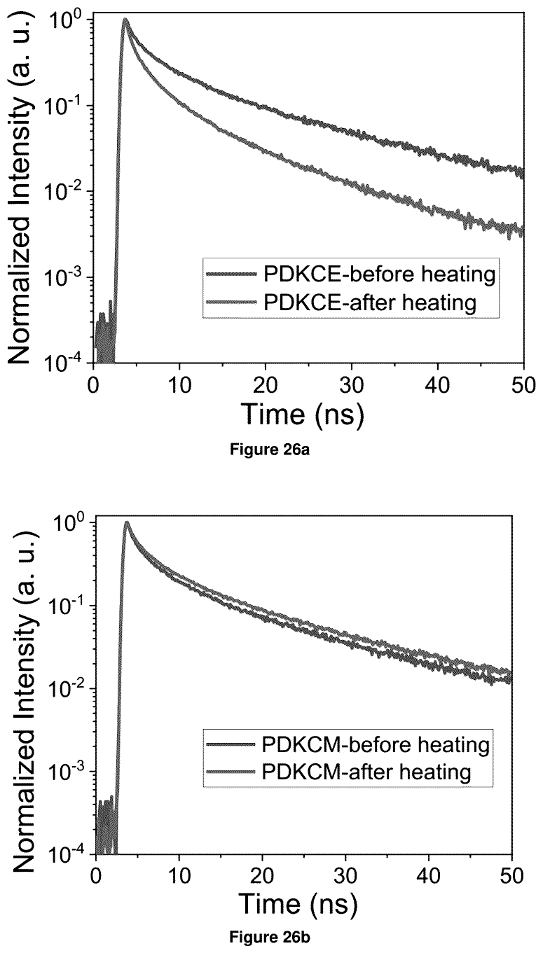

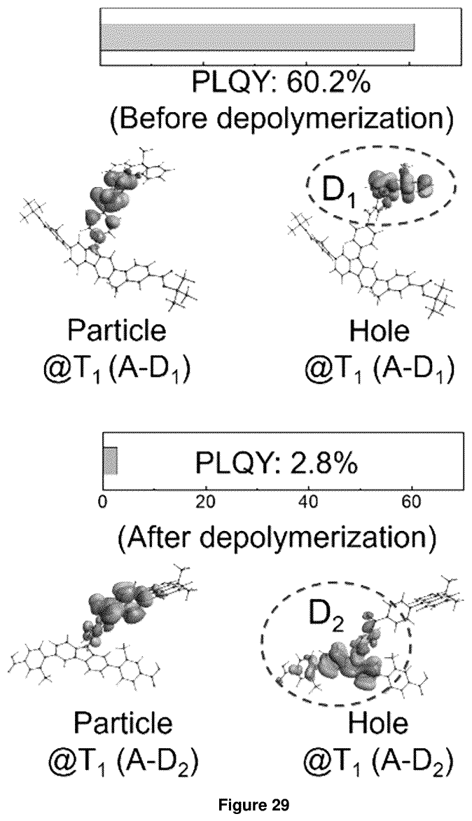

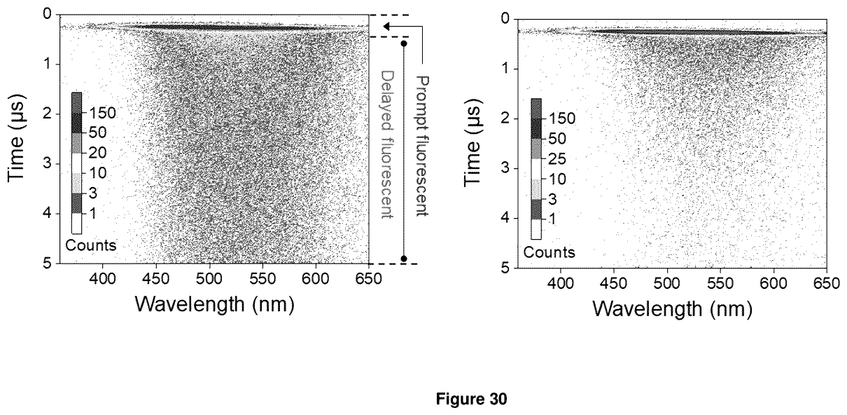

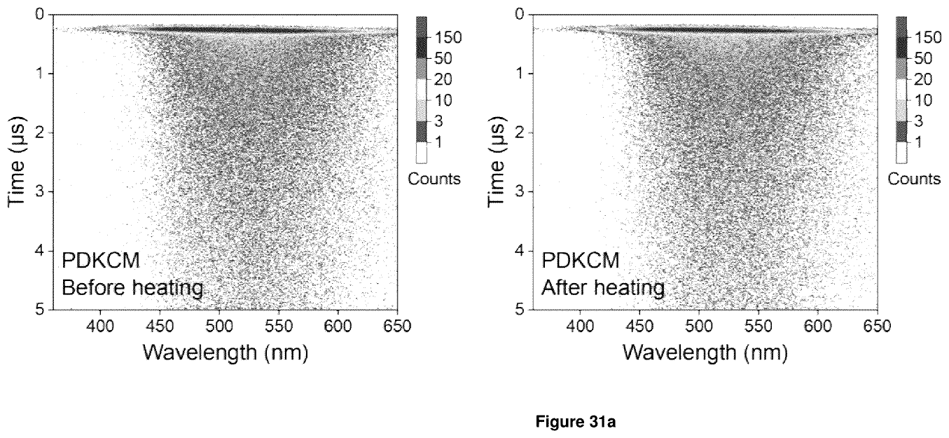

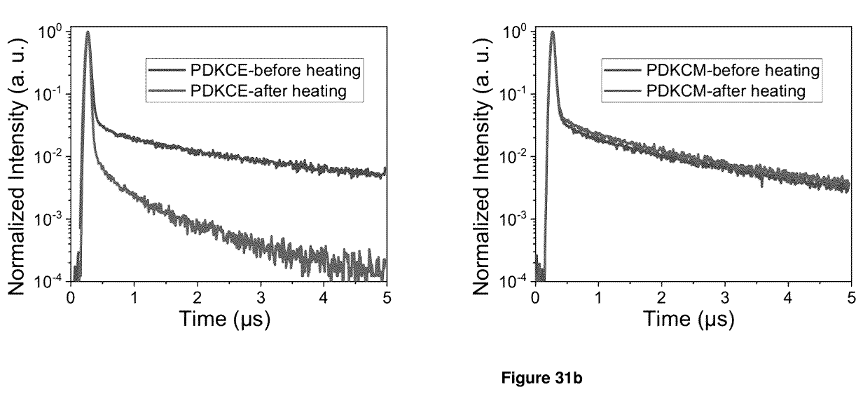

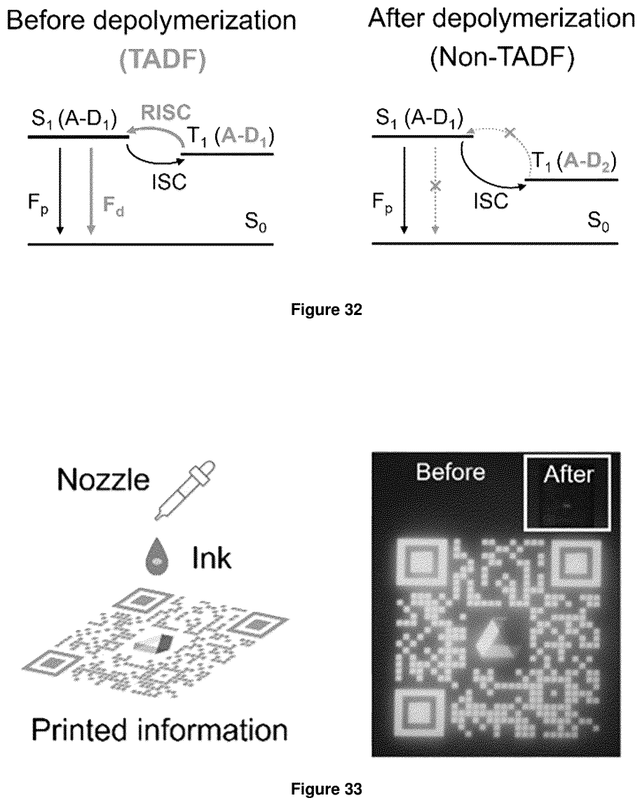

After depolymerization, PDKCE displays a slight red shift with minimal intensity change in the UV-vis spectrum and negligible change in the PL emission spectrum, indicating that the TADF core remained intact with the depolymerization process (FIGS. 26a and 26b). However, the PLQY decreased significantly from 60.9% to 2.8% with depolymerization (FIG. 29), accomplished with the nearly vanished delayed fluorescent emission (FIGS. 30, 31a, and 31b). This was attributed to the generation of carboxylic acid groups which causes a larger ΔE_{ST} for TADF and ultimately leads to the deactivation of TADF due to inefficiency of the RISC process (FIGS. 28 and 32).

Utilizing this depolymerization-induced TADF deactivation, the polymer could serve as a suitable choice for temporary coding materials. For example, the PDKCE polymer was used to print a fluorescence QR code, which could be removed by thermal stress (FIG. 33). In comparison, under these stressors, PDKCM shows negligible property changes reflected with various characterizations, including TGA, UV-vis, PL spectrum, PLQY, and transient PL decay (FIGS. 26a, 26b, 30, 31a, and 32b).

### Example 4—Synthesis and Characterization of Depolymerizable Host-Guest Polymer

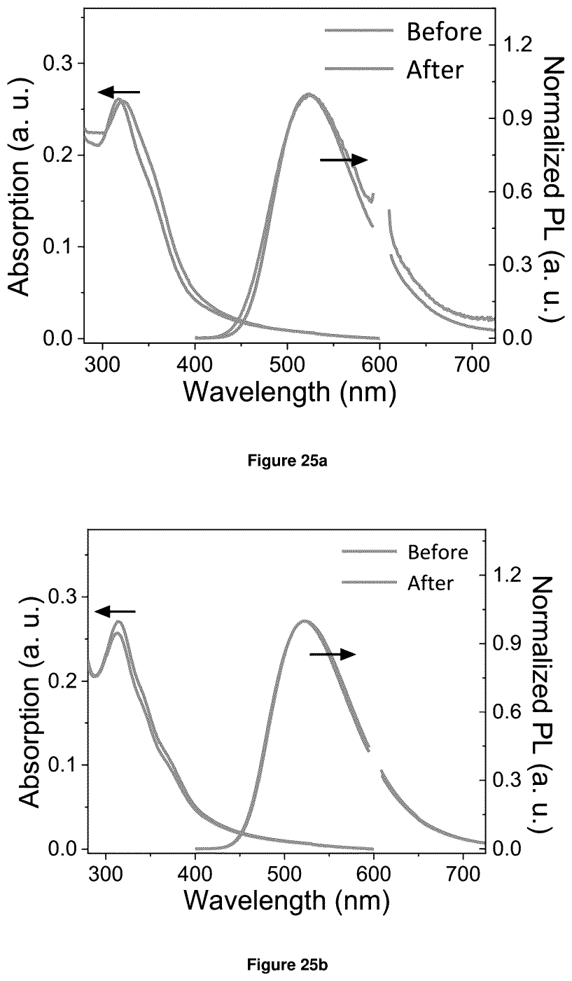

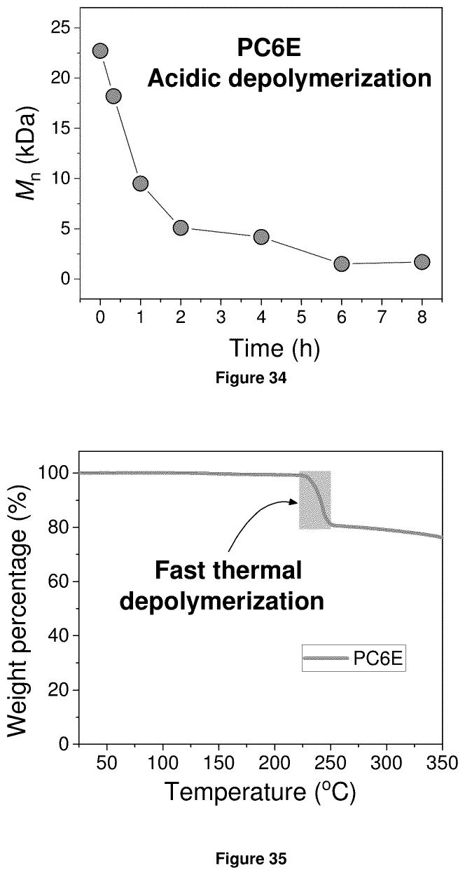

Similar to PDKCE, PC6E demonstrates comparable depolymerization properties under both acidic and thermal stressors, as confirmed by GPC-tracking of the molecular weights and TGA-tracking of mass, respectively, as shown in FIGS. 25a, 25b, 34, and 35.

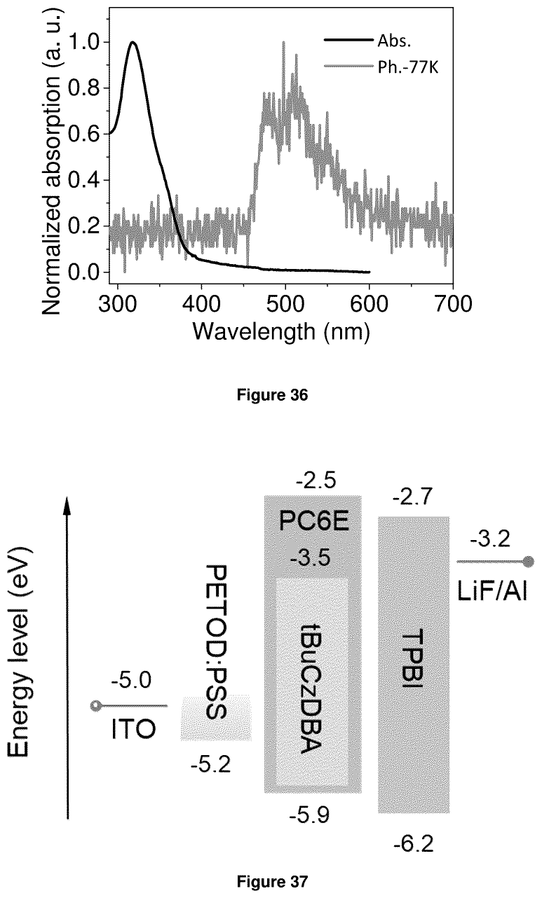

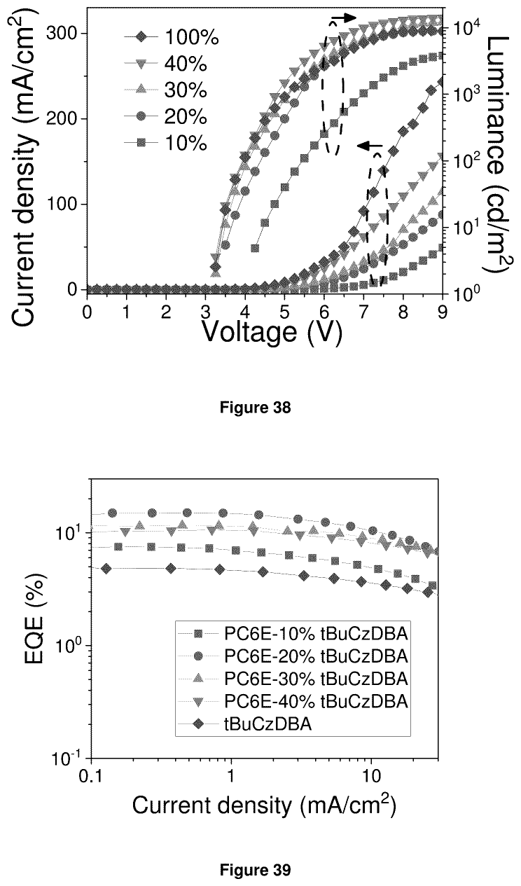

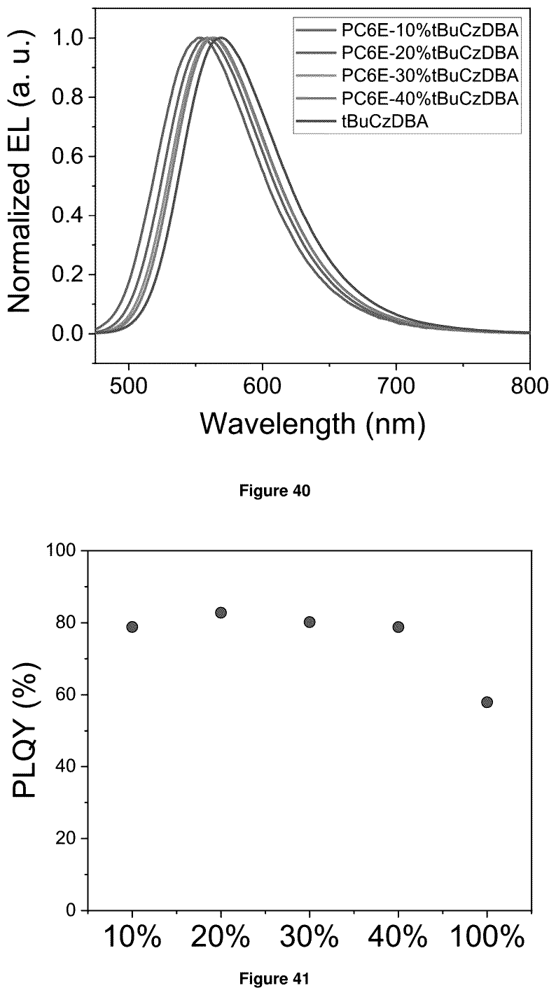

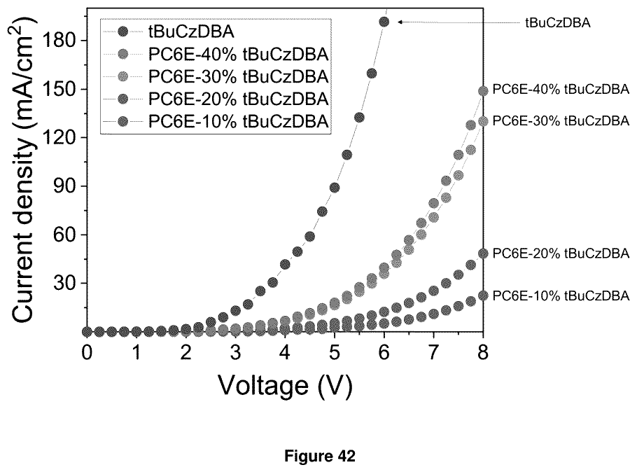

The photophysical properties of the host polymer PC6E were investigated to characterize the host performance of PC6E in the EML system. PC6E exhibits a typical UV-vis spectrum mainly from the localized excited state of carbazole groups (FIG. 36). T₁ was estimated by the onset of the low temperature (77K) phosphorescence to be 2.71 eV, which is high enough for most of TADF emitters (FIG. 36). In particular, the previously reported guest emitter tBuCzDBA was selected to blend with the host polymer PC6E through spin-coating (FIG. 37), which has well-matched T₁ energy levels and also good solution co-processibility. (Wu, T.-L. et al. Nat. Photonics 12, 235-240 (2018)) For EMLs deposited through spin-coating with varied doping ratios between 10% to 40%, the EL performance was tested using the same OLED device structure as above (FIGS. 38, 39, and 40). Compared to the tBuCzDBA guest-only EML, all these host-guest EMLs give EQEs, consistent with the PLQY results (FIG. 41), which indicated the suppression of the exciton quenching from the host-guest design. With the increase of the doping ratio from 10% to 40%, the current density and luminance gradually increased at the same voltage. This could be due to the lower LUMO level of the guest material as compared to the host, which facilitated easier direct electron injection to the guest (FIGS. 10b and 37) and increased charge mobility as shown in FIG. 42. Notably, this polymer resulted in a EQE of 15.1% (FIG. 39), which is an order of magnitude larger compared to previously reported systems.

What is claimed is:

1. A depolymerizable and luminescent polymer having a structure of formula (I): 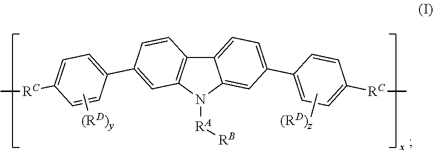
wherein:
x is an integer selected from 0 to 50;
R^{A} is an electron acceptor group;
R^{B} is an electron donor group;
R^{C} is a linker group, comprising R^{E}—(CH₂)ₙ—R^{E}, R^{E}—C(CH₃)₂(CH₂)ₙC(CH₃)₂—R^{E}, R^{E}—(CH₂CH₂O)ₙ—R^{E}, or R^{E}—(Si(CH₃)₂O)ₙ—R^{E};
R^{E} is 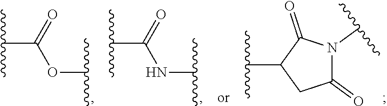
each n is 1 or 2;
each y and z are independently 0, 1, or 2; and
R^{D} is C₁₋₆alkyl or C₁₋₆haloalkyl.

2. The polymer of claim 1, wherein the electron acceptor group is selected from

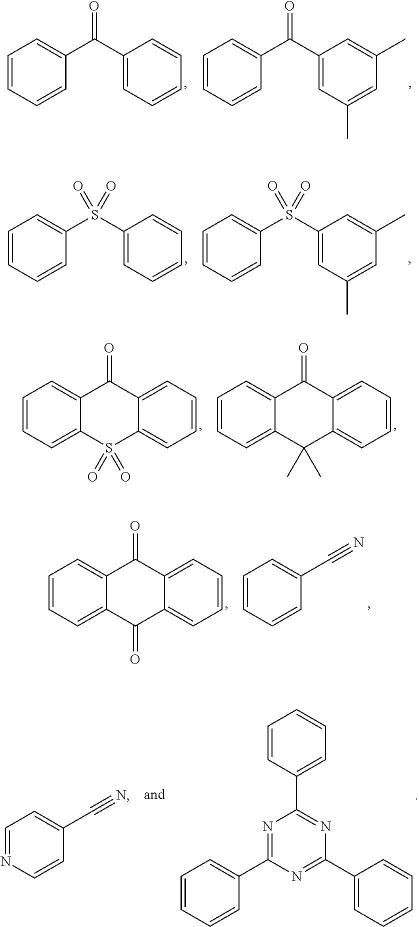

3. The polymer of claim 1, wherein the electron acceptor group is selected from

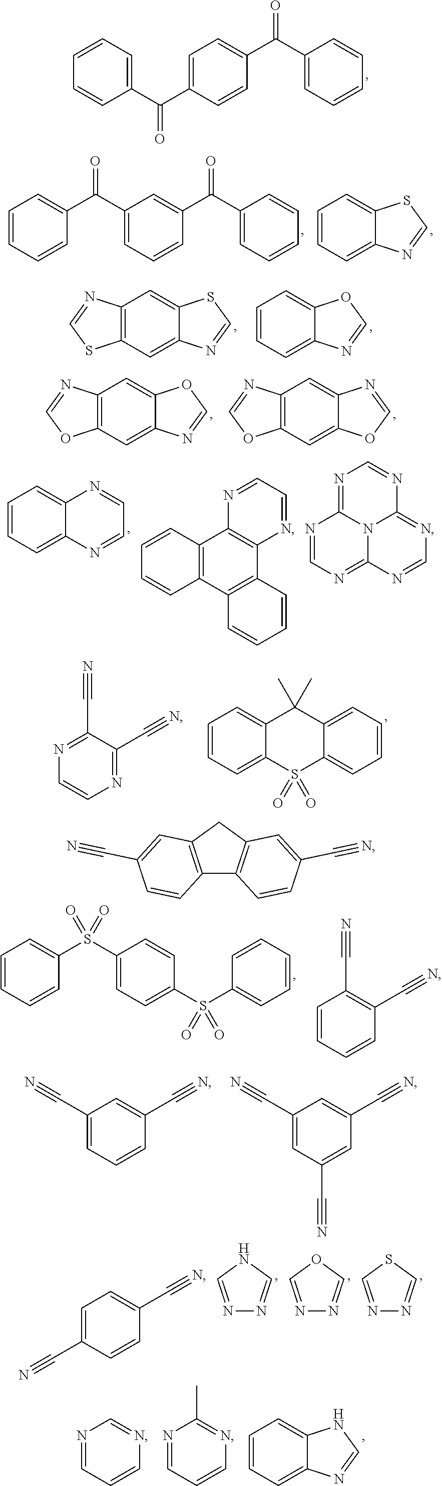

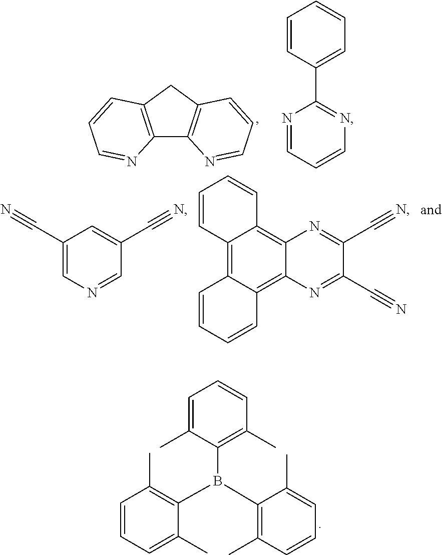

4. The polymer of claim 1, wherein the electron donor group is selected from

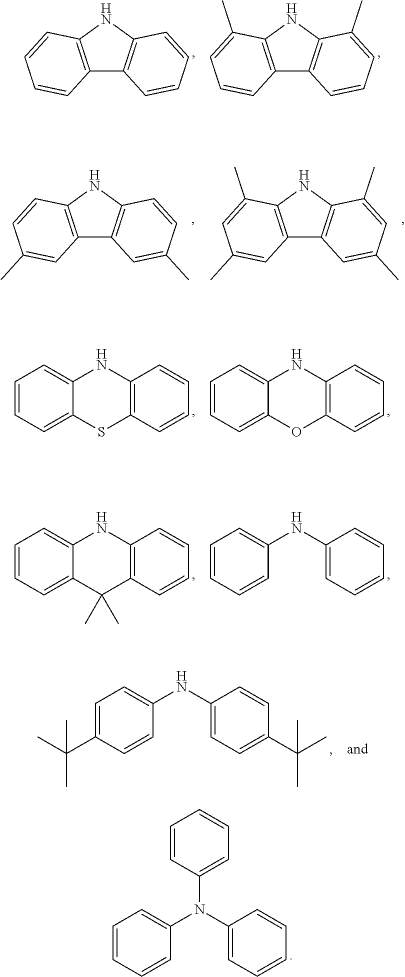

5. The polymer of claim 1, wherein the electron donor group is selected from

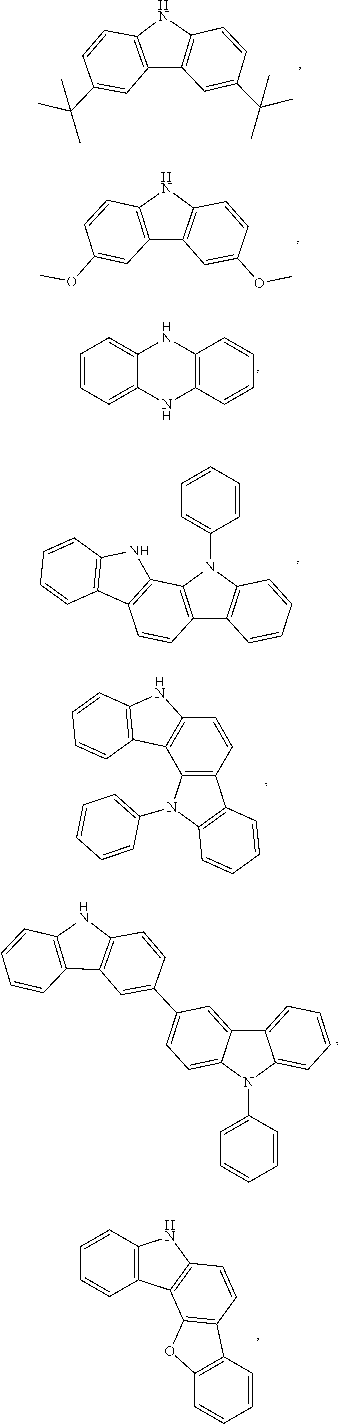

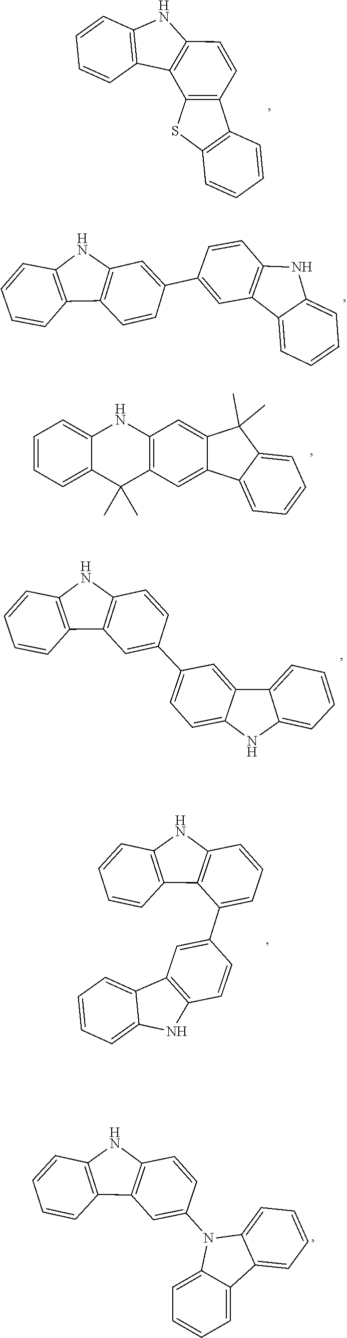

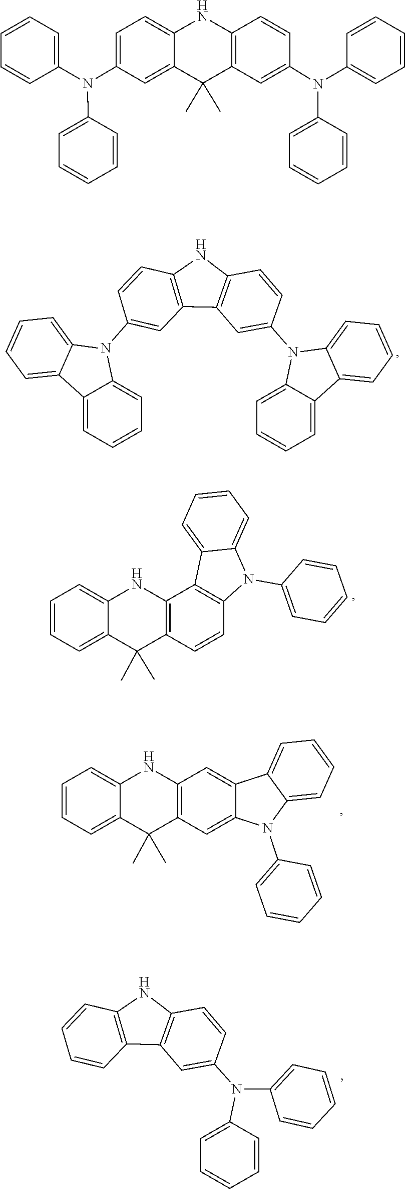 [SMILES: CC1(C)c2cc(N(c3ccccc3)c3ccccc3)ccc2Nc2ccc(N(c3ccccc3)c3ccccc3)cc21 ; c1ccc2c(c1)c1ccccc1n2-c1ccc2[nH]c3ccc(-n4c5ccccc5c5ccccc54)cc3c2c1 ; CC1(C)c2ccccc2Nc2c1ccc1c2c2ccccc2n1-c1ccccc1 ; CC1(C)c2ccccc2Nc2cc3c4ccccc4n(-c4ccccc4)c3cc21 ; c1ccc(N(c2ccccc2)c2ccc3[nH]c4ccccc4c3c2)cc1]

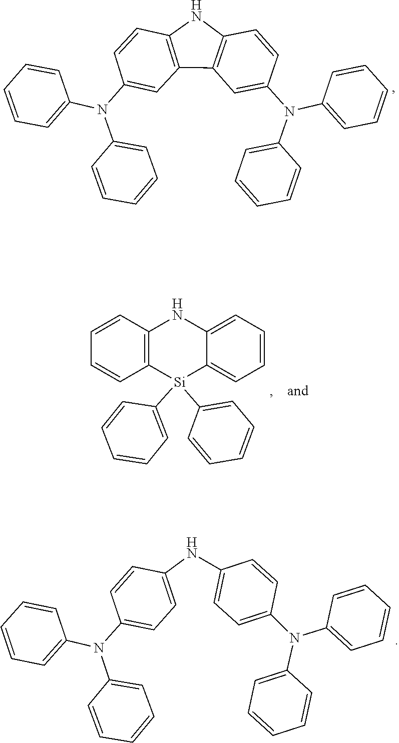 [SMILES: c1ccc(N(c2ccccc2)c2ccc3[nH]c4ccc(N(c5ccccc5)c5ccccc5)cc4c3c2)cc1 ; c1ccc([Si]2(c3ccccc3)c3ccccc3Nc3ccccc32)cc1 ; c1ccc(N(c2ccccc2)c2ccc(Nc3ccc(N(c4ccccc4)c4ccccc4)cc3)cc2)cc1]

6. The polymer of claim 1, wherein the linker group is R^{E}—(CH₂)ₙ—R^{E}, R^{E}—C(CH₃)₂(CH₂)ₙC(CH₃)₂—R^{E}, or R^{E}—(CH₂CH₂O)ₙ—R^{E}.

7. The polymer of claim 1, wherein n is 2.

8. The polymer of claim 1, wherein RE is

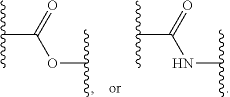 [SMILES: *OC(*)=O ; *NC(*)=O]

9. The polymer of claim 1, wherein the linker group is R^{E}—(CH₂)ₙ—R^{E} or R^{E}—C(CH₃)₂(CH₂)ₙC(CH₃)₂—R^{E} and R^{E} is

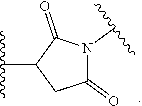 [SMILES: *C1CC(=O)N(*)C1=O]

10. The polymer of claim 1, wherein each of y and z are 1 or 2 and each R^{D} is CH₃ or CF₃.

11. The polymer of claim 1, wherein:
R^{A} is 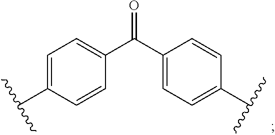 [SMILES: *c1ccc(C(=O)c2ccc(*)cc2)cc1]
R^{B} is 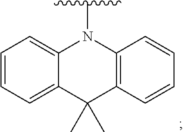 [SMILES: *N1c2ccccc2C(C)(C)c2ccccc21]
R^{C} is R^{E}—C(CH₃)₂(CH₂)₂C(CH₃)₂—R^{E};
R^{E} is 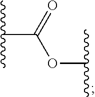 [SMILES: *OC(*)=O]
each of y and z are 1; and
R^{D} is CH₃.

12. A depolymerizable and luminescent polymer, comprising a plurality of guest emitters dispersed in a host polymer, wherein:
the host polymer comprises a plurality of host monomers and a plurality of cleavable linker groups, and
the plurality of cleavable linker groups comprise one or more of R^{E}—(CH₂)ₙ—R^{E}, R^{E}—C(CH₃)₂(CH₂)ₙC(CH₃)₂—R^{E}, R^{E}—(CH₂CH₂O)ₙ—R^{E}, and R^{E}—(Si(CH₃)₂O)ₙ—R^{E}, wherein in each linker group,
each n is 1 or 2; and
R^{E} is

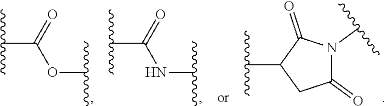

13. The polymer of claim 12, wherein the plurality of host monomers comprises one or more of acridine, fluorene, and carbazole, optionally substituted with 1 or 2 C₁₋₆alkyl groups.

14. The polymer of claim 12, wherein the plurality of host monomers comprises one or more of

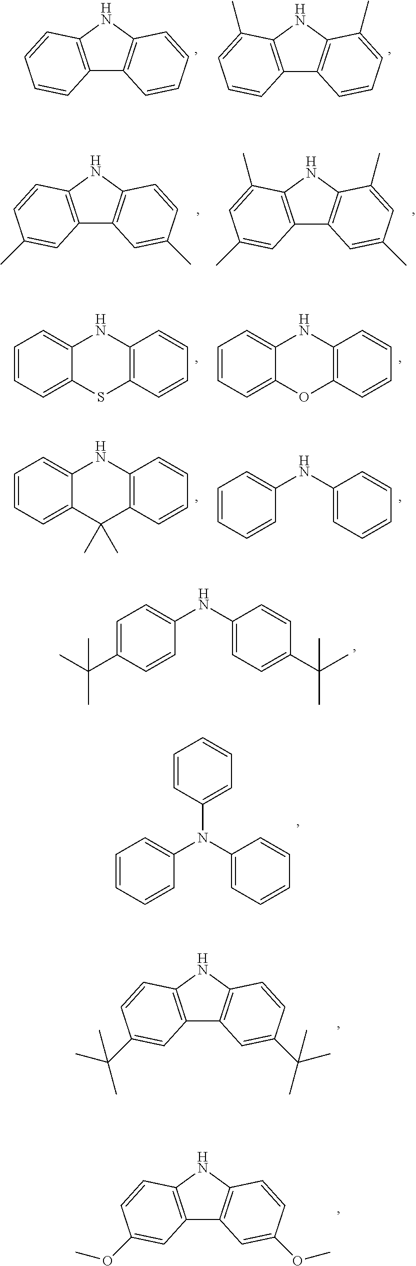

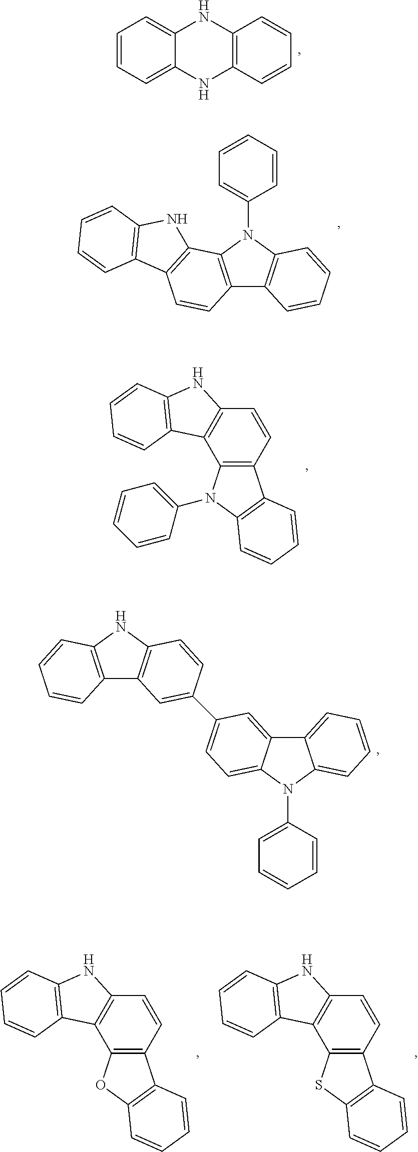 [SMILES: c1ccc2c(c1)Nc1ccccc1N2 ; c1ccc(-n2c3ccccc3c3ccc4c5ccccc5[nH]c4c32)cc1 ; c1ccc(-n2c3ccccc3c3ccc4[nH]c5ccccc5c4c32)cc1 ; c1ccc(-n2c3ccccc3c3cc(-c4ccc5[nH]c6ccccc6c5c4)ccc32)cc1 ; c1ccc2c(c1)[nH]c1ccc3c4ccccc4oc3c12 ; c1ccc2c(c1)[nH]c1ccc3c4ccccc4sc3c12]

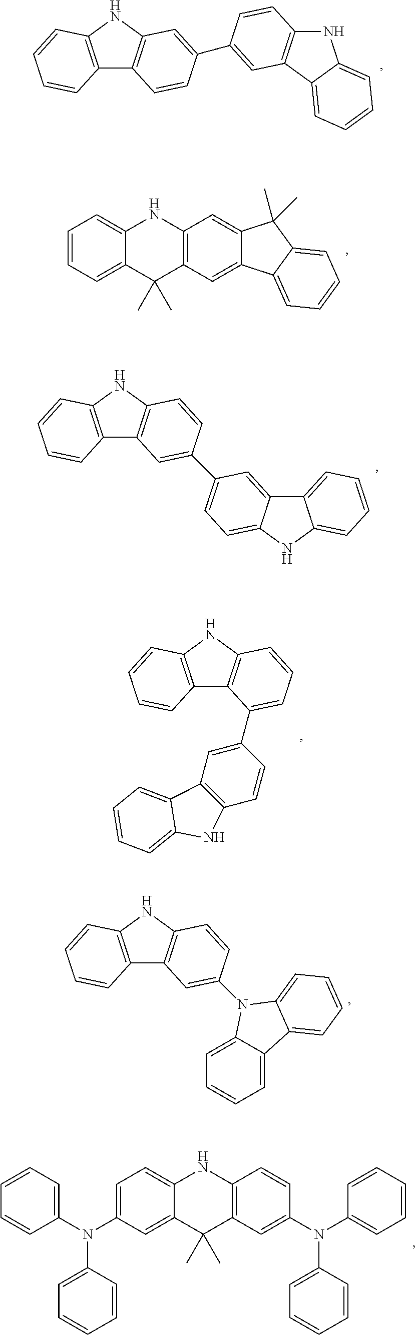 [SMILES: c1ccc2c(c1)[nH]c1cc(-c3ccc4[nH]c5ccccc5c4c3)ccc12 ; CC1(C)c2ccccc2Nc2cc3c(cc21)-c1ccccc1C3(C)C ; c1ccc2c(c1)[nH]c1ccc(-c3ccc4[nH]c5ccccc5c4c3)cc12 ; c1ccc2c(c1)[nH]c1ccc(-c3cccc4[nH]c5ccccc5c34)cc12 ; c1ccc2c(c1)[nH]c1ccc(-n3c4ccccc4c4ccccc43)cc12 ; CC1(C)c2cc(N(c3ccccc3)c3ccccc3)ccc2Nc2ccc(N(c3ccccc3)c3ccccc3)cc21]

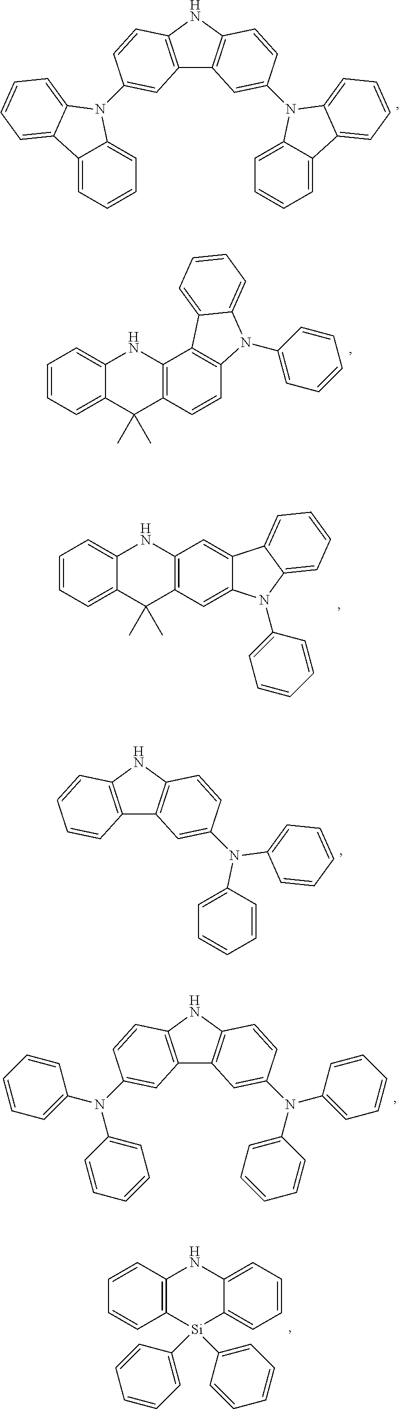 [SMILES: c1ccc2c(c1)c1ccccc1n2-c1ccc2[nH]c3ccc(-n4c5ccccc5c5ccccc54)cc3c2c1 ; CC1(C)c2ccccc2Nc2c1ccc1c2c2ccccc2n1-c1ccccc1 ; CC1(C)c2ccccc2Nc2cc3c4ccccc4n(-c4ccccc4)c3cc21 ; c1ccc(N(c2ccccc2)c2ccc3[nH]c4ccccc4c3c2)cc1 ; c1ccc(N(c2ccccc2)c2ccc3[nH]c4ccc(N(c5ccccc5)c5ccccc5)cc4c3c2)cc1 ; c1ccc([Si]2(c3ccccc3)c3ccccc3Nc3ccccc32)cc1]

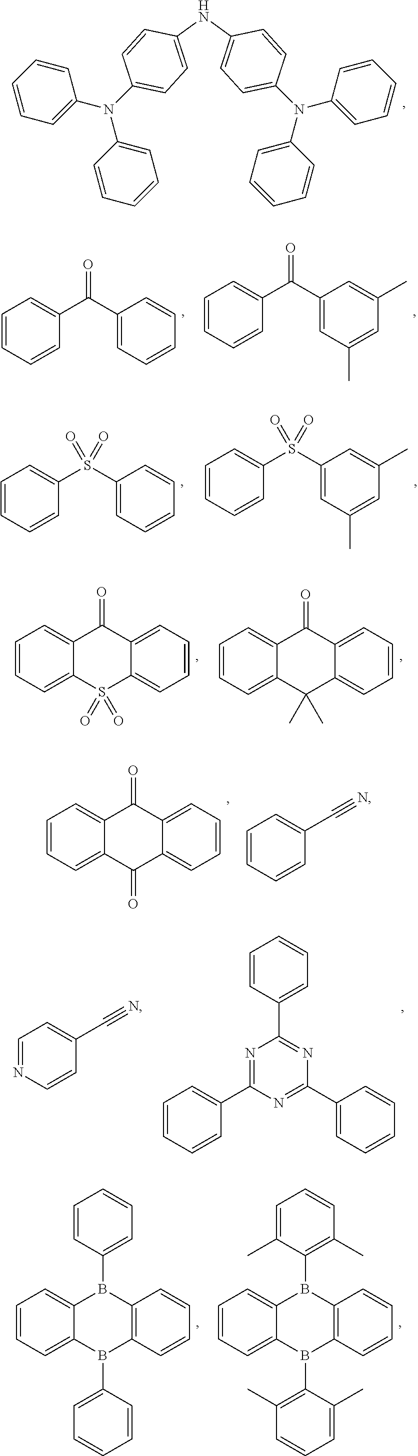

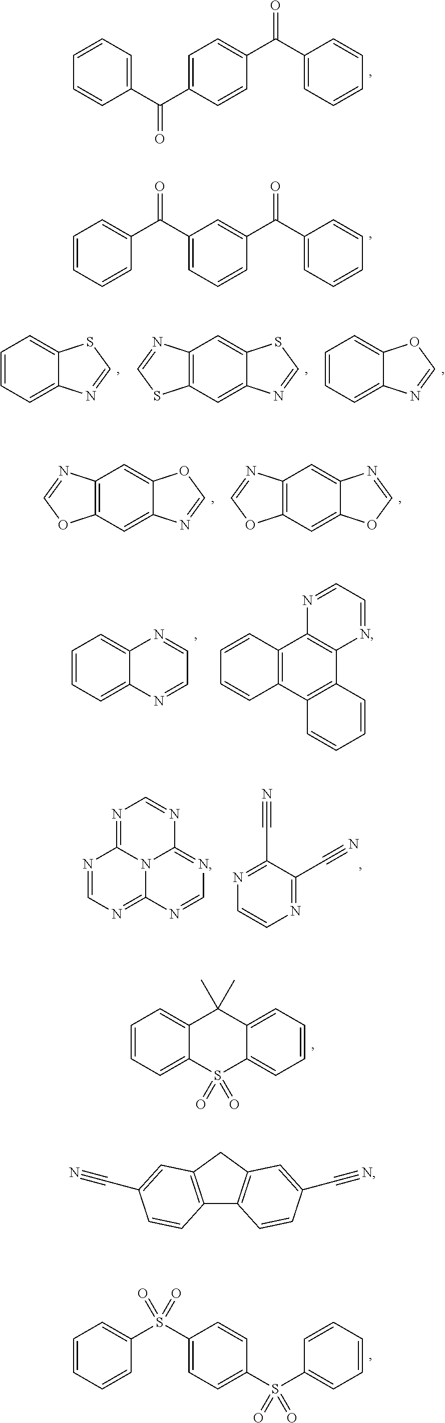

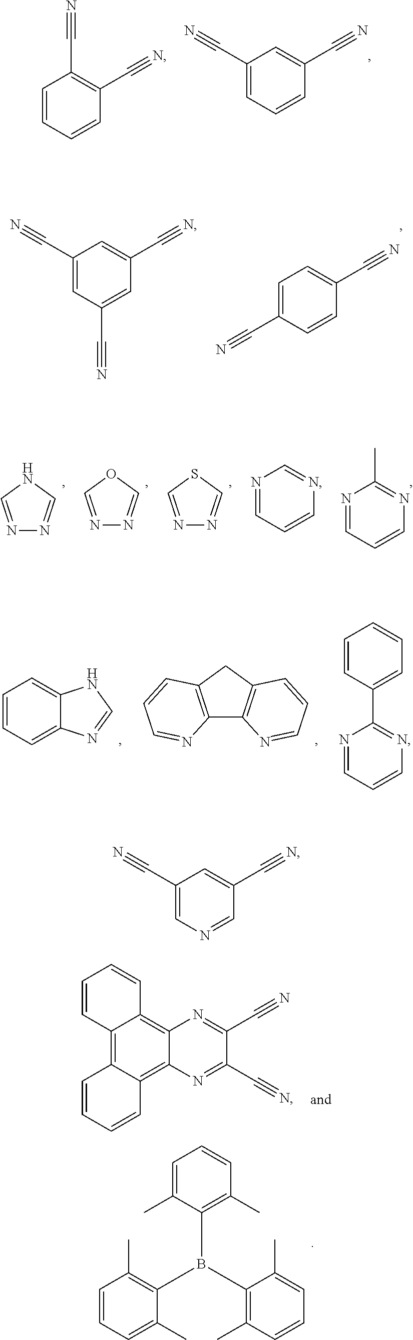

15. The polymer of claim 12, wherein the plurality of linker groups comprises one or more of R^{E}—(CH₂)ₙ—R^{E}, R^{E}—C(CH₃)₂(CH₂)ₙC(CH₃)₂—R^{E} and R^{E}—(CH₂CH₂O)ₙ—R^{E}.

16. The polymer of claim 12, wherein R^{E} is

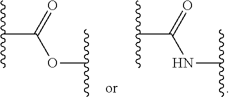 [SMILES: *OC(*)=O ; *NC(*)=O]

17. The polymer of claim 12, wherein the plurality of guest emitters comprises one or more electron acceptor group selected from

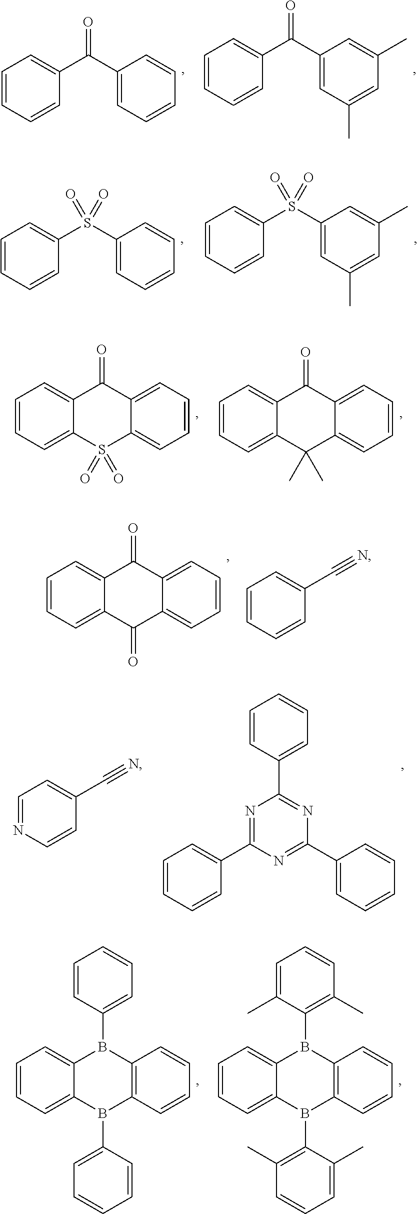

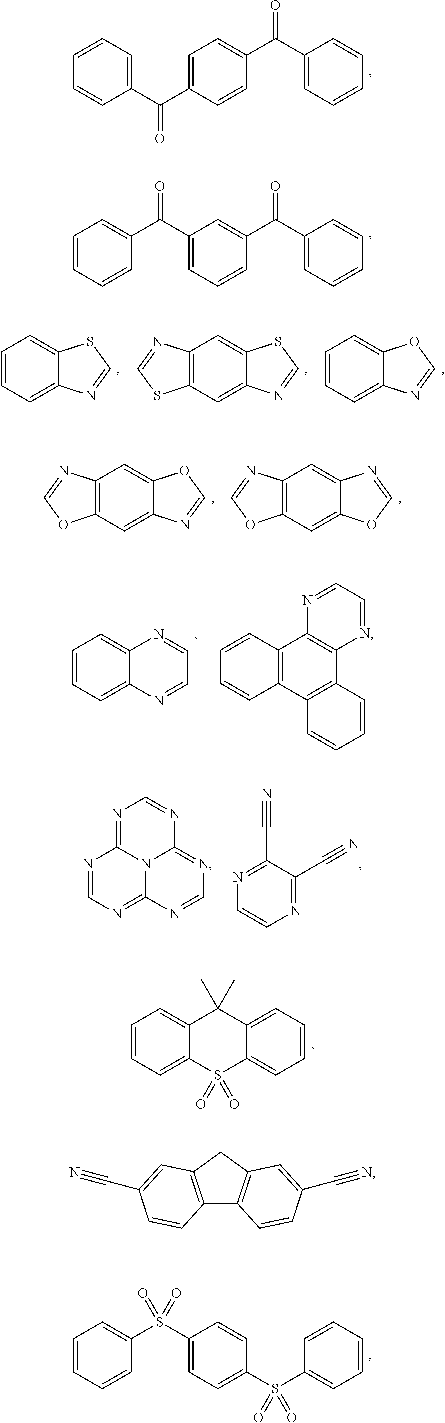

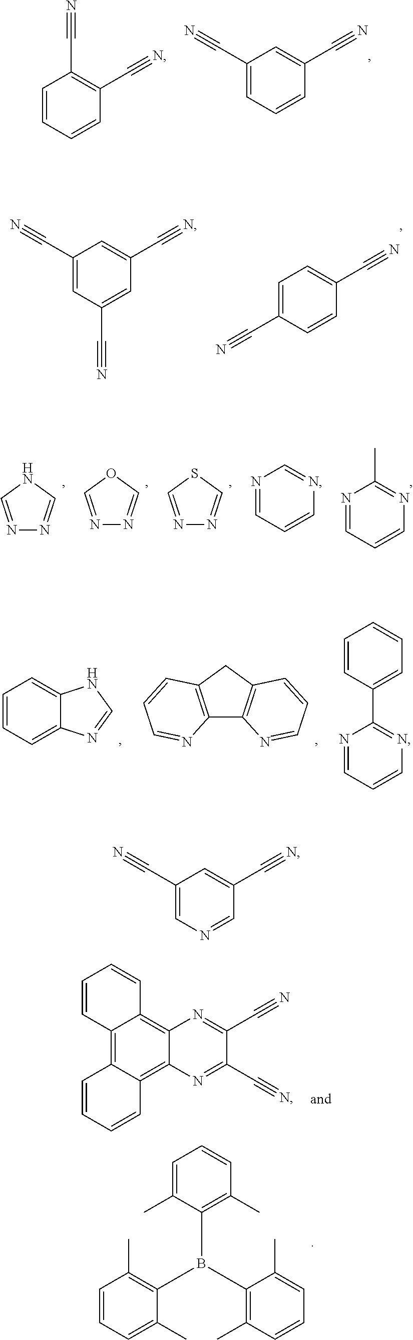

18. The polymer of claim 12, wherein the plurality of guest emitters comprises one or more electron donor groups selected from

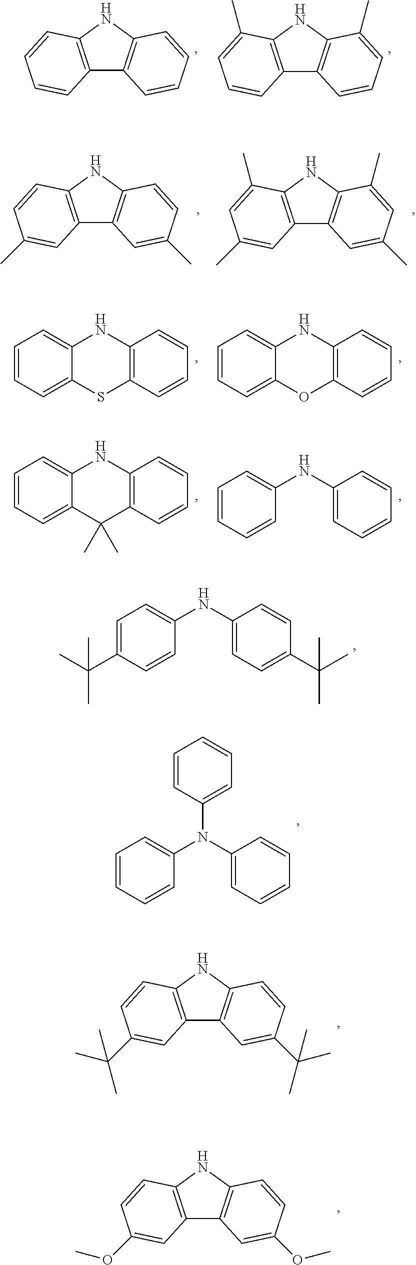

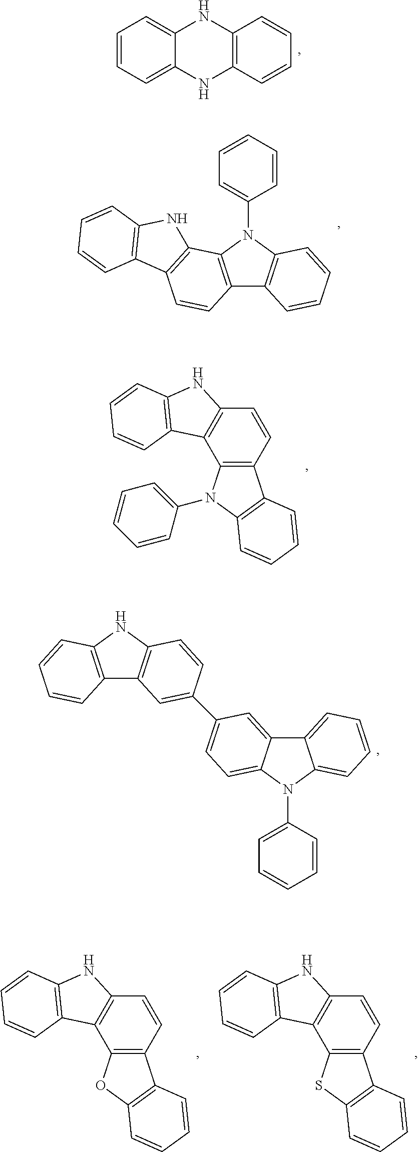 [SMILES: c1ccc2c(c1)Nc1ccccc1N2 ; c1ccc(-n2c3ccccc3c3ccc4c5ccccc5[nH]c4c32)cc1 ; c1ccc(-n2c3ccccc3c3ccc4[nH]c5ccccc5c4c32)cc1 ; c1ccc(-n2c3ccccc3c3cc(-c4ccc5[nH]c6ccccc6c5c4)ccc32)cc1 ; c1ccc2c(c1)[nH]c1ccc3c4ccccc4oc3c12 ; c1ccc2c(c1)[nH]c1ccc3c4ccccc4sc3c12]

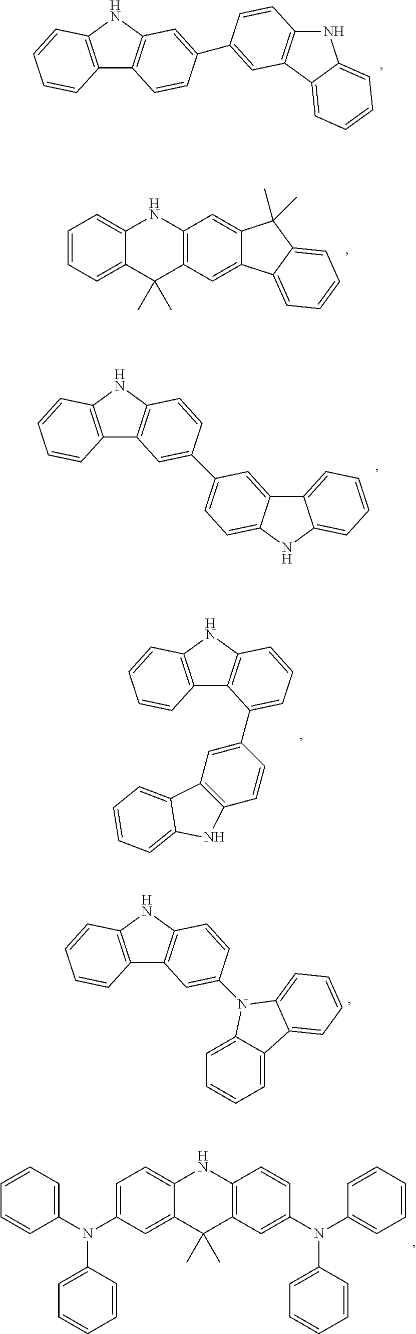 [SMILES: c1ccc2c(c1)[nH]c1cc(-c3ccc4[nH]c5ccccc5c4c3)ccc12 ; CC1(C)c2ccccc2Nc2cc3c(cc21)-c1ccccc1C3(C)C ; c1ccc2c(c1)[nH]c1ccc(-c3ccc4[nH]c5ccccc5c4c3)cc12 ; c1ccc2c(c1)[nH]c1ccc(-c3cccc4[nH]c5ccccc5c34)cc12 ; c1ccc2c(c1)[nH]c1ccc(-n3c4ccccc4c4ccccc43)cc12 ; CC1(C)c2cc(N(c3ccccc3)c3ccccc3)ccc2Nc2ccc(N(c3ccccc3)c3ccccc3)cc21]

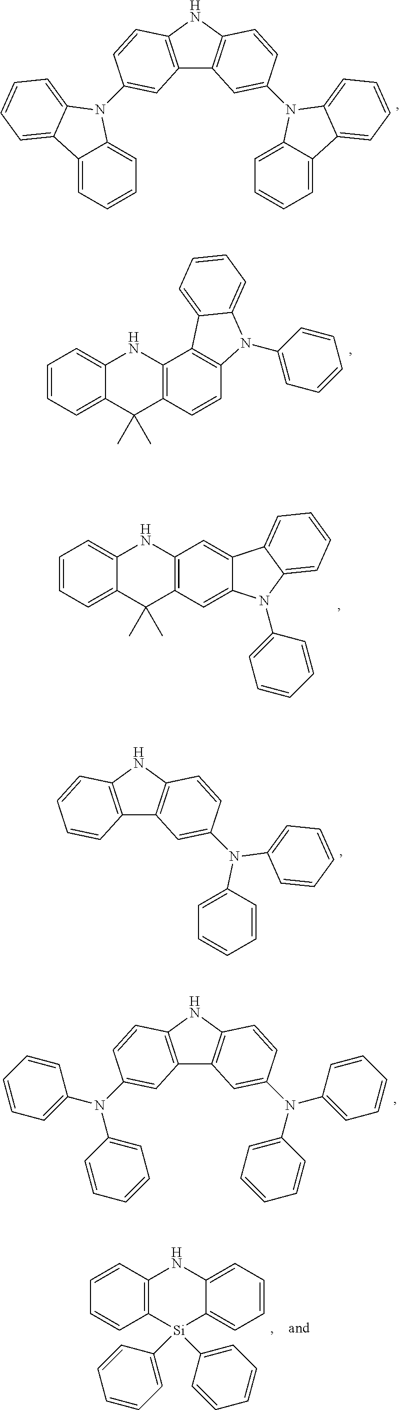 [SMILES: c1ccc2c(c1)c1ccccc1n2-c1ccc2[nH]c3ccc(-n4c5ccccc5c5ccccc54)cc3c2c1 ; CC1(C)c2ccccc2Nc2c1ccc1c2c2ccccc2n1-c1ccccc1 ; CC1(C)c2ccccc2Nc2cc3c4ccccc4n(-c4ccccc4)c3cc21 ; c1ccc(N(c2ccccc2)c2ccc3[nH]c4ccccc4c3c2)cc1 ; c1ccc(N(c2ccccc2)c2ccc3[nH]c4ccc(N(c5ccccc5)c5ccccc5)cc4c3c2)cc1 ; c1ccc([Si]2(c3ccccc3)c3ccccc3Nc3ccccc32)cc1]

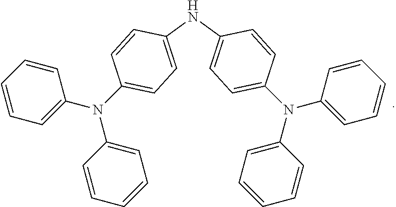 [SMILES: c1ccc(N(c2ccccc2)c2ccc(Nc3ccc(N(c4ccccc4)c4ccccc4)cc3)cc2)cc1]

19. The polymer of claim 12, wherein the plurality of guest emitters comprises one or more of

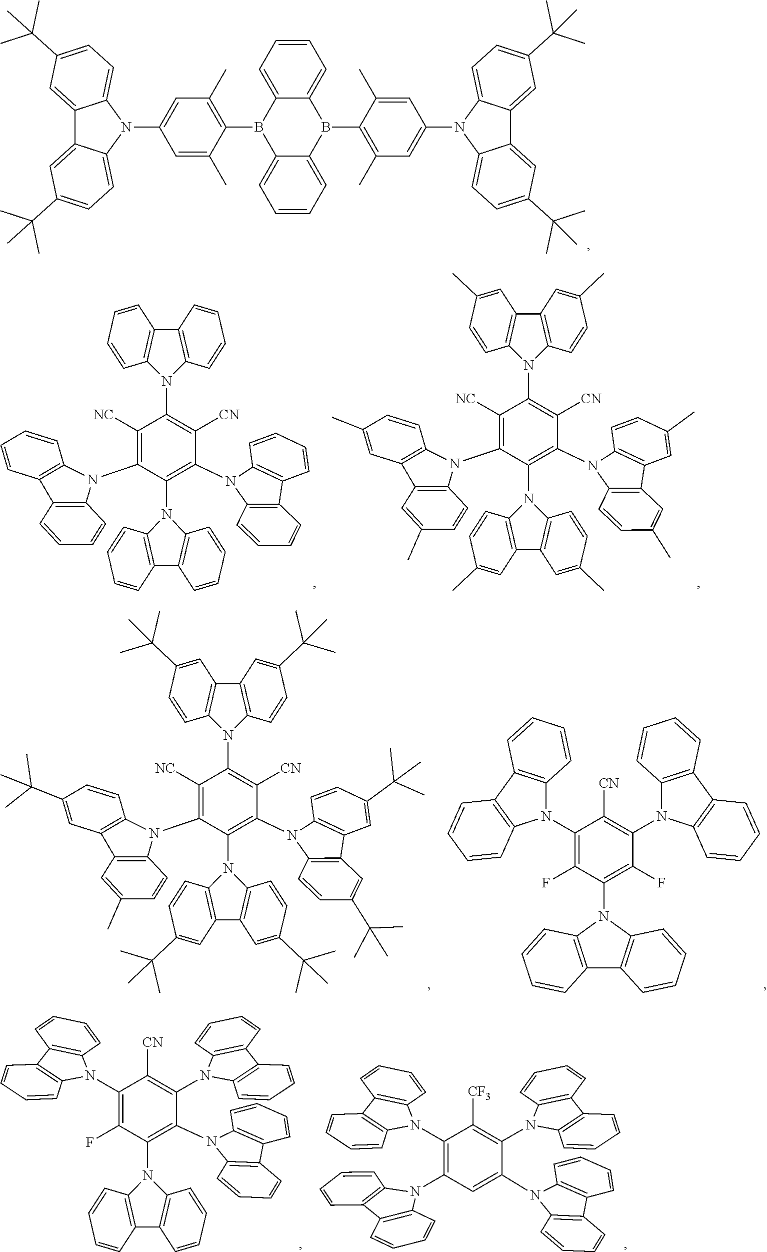

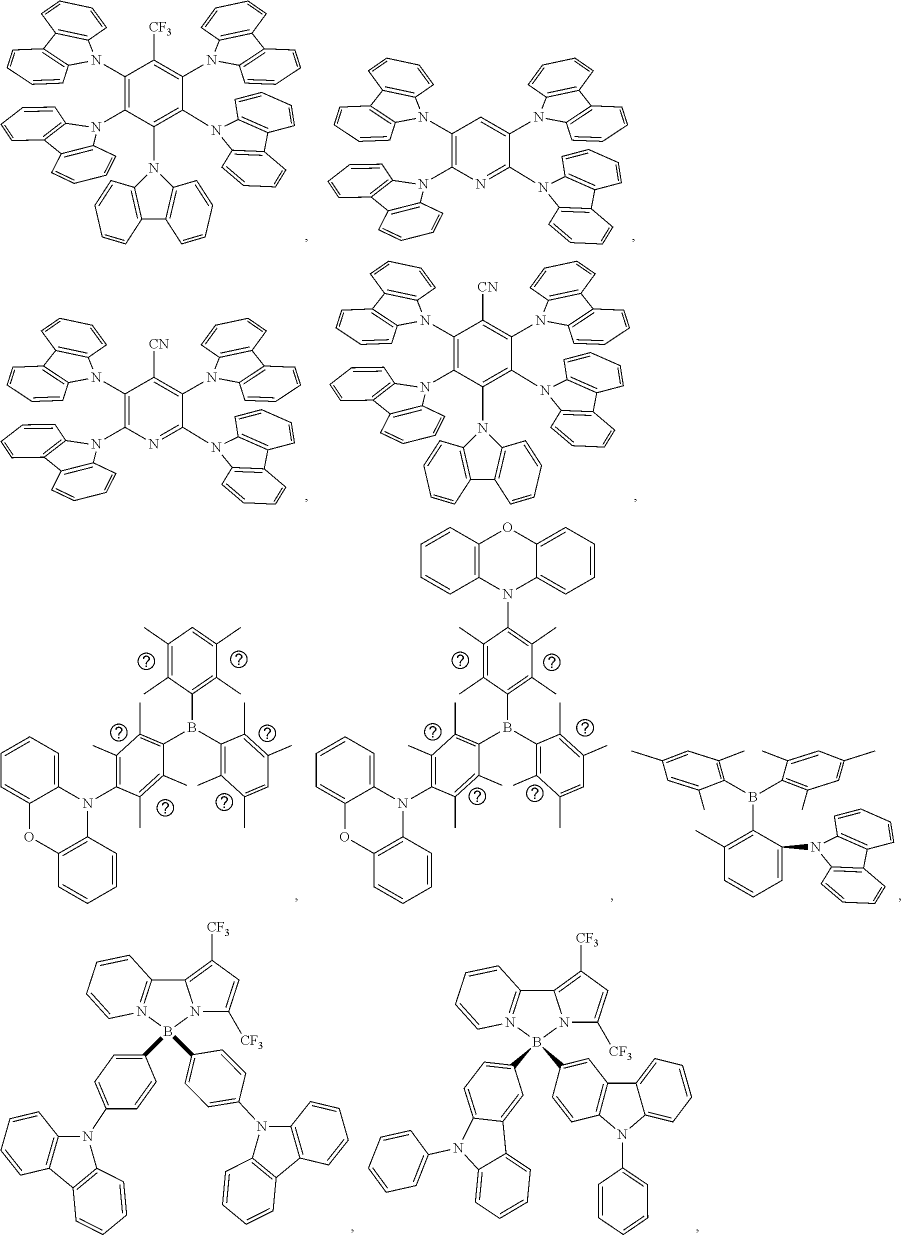

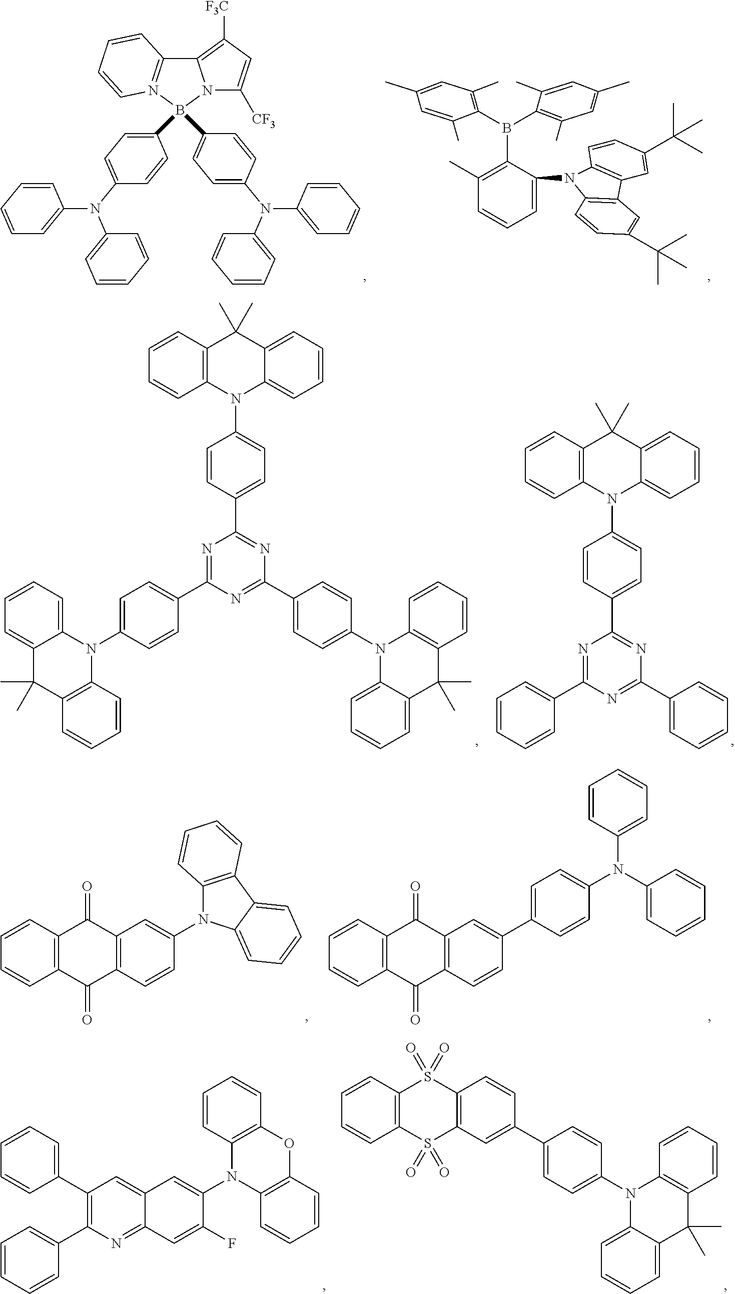

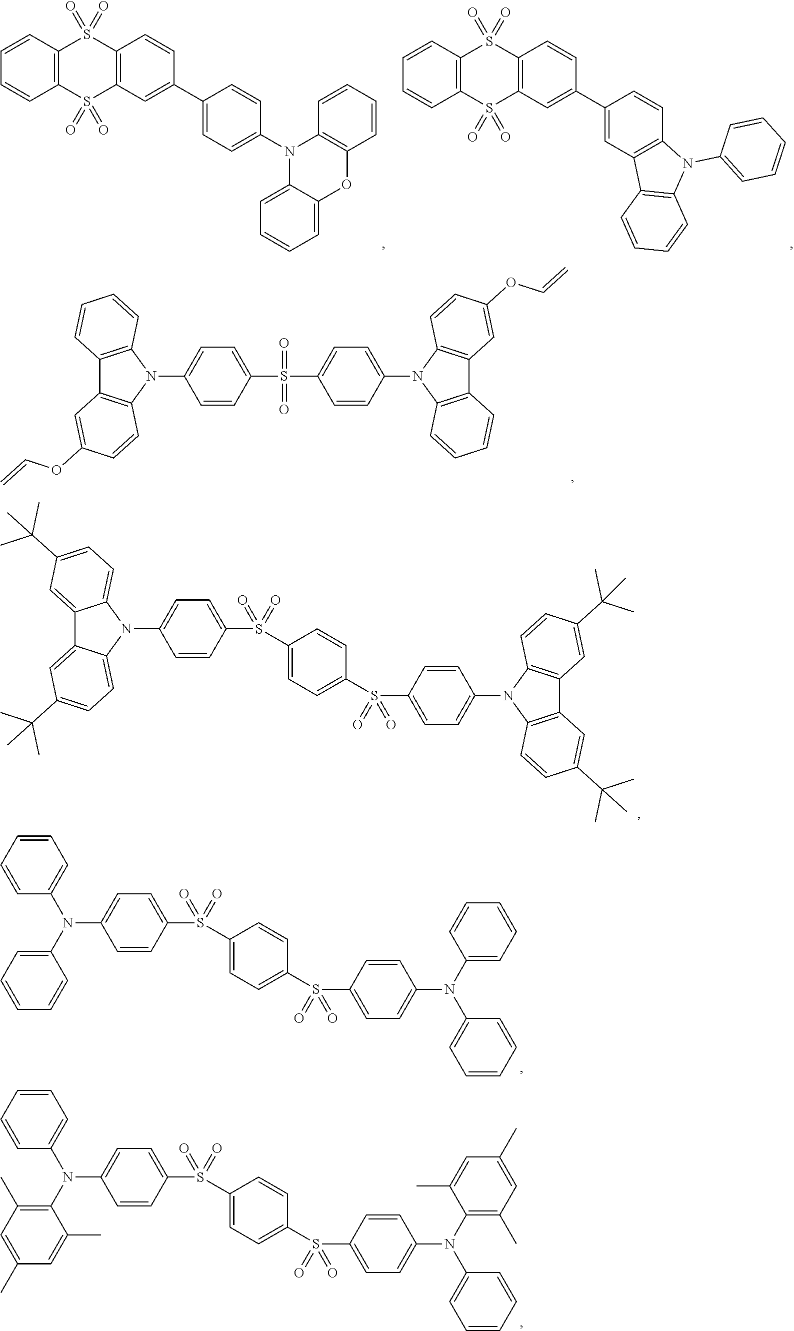

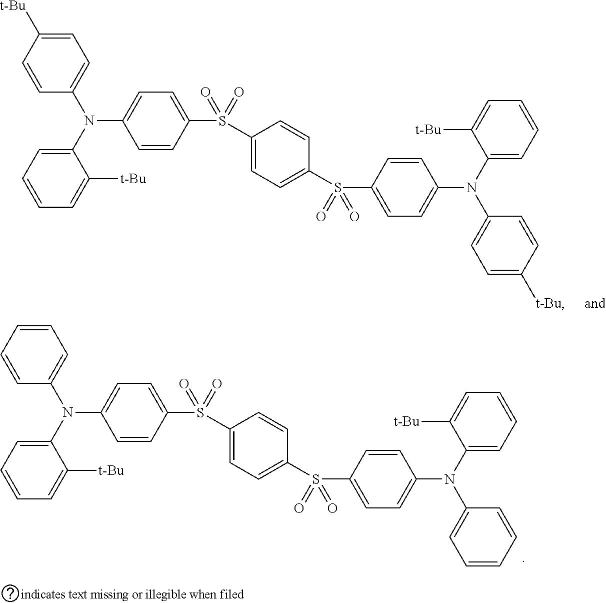 [SMILES: CC(C)(C)c1ccc(N(c2ccc(S(=O)(=O)c3ccc(S(=O)(=O)c4ccc(N(c5ccc(C(C)(C)C)cc5)c5ccccc5C(C)(C)C)cc4)cc3)cc2)c2ccccc2C(C)(C)C)cc1 ; CC(C)(C)c1ccccc1N(c1ccccc1)c1ccc(S(=O)(=O)c2ccc(S(=O)(=O)c3ccc(N(c4ccccc4)c4ccccc4C(C)(C)C)cc3)cc2)cc1]

20. The polymer of claim 12, wherein:
the host monomer is 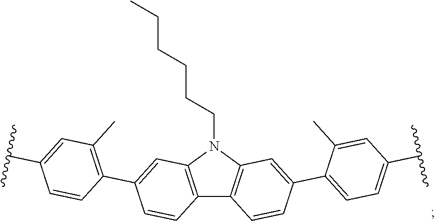 [SMILES: *c1ccc(-c2ccc3c4ccc(-c5ccc(*)cc5C)cc4n(CCCCCC)c3c2)c(C)c1]
the linker group is R^{E}—C(CH₃)₂(CH₂)₂C(CH₃)₂—R^{E};
R^{E} is 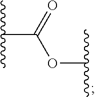 [SMILES: *OC(*)=O]
and (ii) the guest emitter is 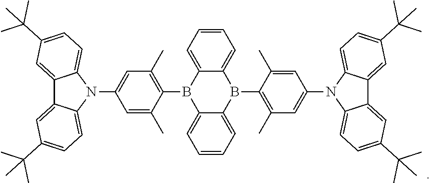 [SMILES: Cc1cc(-n2c3ccc(C(C)(C)C)cc3c3cc(C(C)(C)C)ccc32)cc(C)c1B1c2ccccc2B(c2c(C)cc(-n3c4ccc(C(C)(C)C)cc4c4cc(C(C)(C)C)ccc43)cc2C)c2ccccc21]
